(19) United States
(12) Patent Application Publication
(10) Pub. No.: US 2021/0150546 A1
(43) Pub. Date: May 20, 2021

(54) System, Method, and User Interface for Facilitating Product Research and Development

(71) Applicant: Midea Group Co., Ltd., Foshan (CN)

(72) Inventors: Yujie Zhu, San Jose, CA (US); Suresh Mani, San Jose, CA (US); Yuxuan Wan, San Jose, CA (US); Sathyanarayanan Muthusamy, Livermore, CA (US)

(21) Appl. No.: 16/685,844

(22) Filed: Nov. 15, 2019

(51) Int. Cl. G06Q 30/02

(52) U.S. Cl. CPC G06Q 30/0201; G06F 17/27; G06Q 30/0282

(57) ABSTRACT

A method and system of facilitating product research and development, comprising: obtaining respective product-related data from a plurality of data sources, including product-specific data for a plurality of products, and non-product-specific data including at least one of talent profile data and technology description data; performing topic extraction on the respective product-specific data and the non-product-specific data to obtain respective topics associated with the plurality of products and corresponding numerical statistics for the respective topics; performing sentiment analysis on the respective product-specific data for a plurality of products for the respective topics to obtain respective values of a measure of consumer sentiment corresponding to the respective topics for a respective product; and presenting an integrated sentiment review of a selected product based on the respective values of the measure of consumer sentiment corresponding to one or more of the respective topics for the selected product.

### TECHNICAL FIELD

This disclosure relates generally to product research and development systems, and more specifically, to a system, method, and user interface for facilitating product research and development in the home appliance industry.

### BACKGROUND

Product planning and optimization includes designing a new product or improving an existing product that meet market demand and customer needs. Successful product planning and optimization require a market researcher or product planning engineer to do comprehensive analysis on various types of product data, including customer reviews, customer interviews, and/or survey feedbacks. A biased analysis or lack of whole vision of the market will cause an improper product planning and predict products and/or features that cannot meet customer expectations.

In the present, the state of art product planning and optimization methods rely primarily on sales data and online customer reviews, as well as market surveys. Although natural language processing methods and data mining techniques exist for analyzing existing market data and customer surveys, there lacks an efficient way to meaningfully group or filter the data to generate insightful results. Furthermore, the existing out of the box data analysis solutions are inflexible and require much manual design and efforts to tailor to a particular industry or product. Overall, the existing methods and systems for product planning and optimization is limited, slow, expensive and inefficient.

Thus, it would be beneficial to provide an improved system and method to facilitate the product research and development in various industries.

### SUMMARY

As stated in the background section, the current state of the art product planning and optimization methods suffer from low efficiency in collecting and summarizing customer feedbacks. For example, companies use predefined and generic labels in analyzing large amount of e-commerce data to obtain customer sentiments from product reviews. Some companies use in-person interviews to obtain customers feedbacks. However, using predefined labels can lead to biased and limited information obtained from data analysis, and can miss some trend or out-of-box ideas. Further, existing technologies may only focus on the sales of products in general e-commerce. As a result, the existing technologies may be suitable for analysis of marketing and sales of the products, but are insufficient in addressing product research and development. In addition, existing solutions for product research and development is rigid and are not suitable for different ways of selecting data, analyzing data, and visualizing the selected data and the analysis results that may be suitable for different product research and development goals and stages.

Accordingly, there is a need for a method to perform data mining and data analysis to facilitate the research and development of the products (e.g., home appliances and other products).

The embodiments described below provide systems and methods for data mining and data analysis on data obtained from various data resources for research and development of the products. The system and method disclosed herein provide users with more intuitive and interactive product improvement/planning recommendations to help with product research and development. The system (e.g., the platform) disclosed herein uses the topic modeling and sentiment analysis to identify topics of the product(s) to be considered for the product research and development, and sentiments associated with the respective topics. For example, the system generates pros and cons of an identified topic (e.g., a feature) for a product of a filtered brand, competitor, and/or data source. As a result, the system can provide complete and comprehensive recommendations for product planning, research, development, as well as marketing, sales, and services. In some embodiments, the system (e.g., the platform) uses one or more algorithms to perform the data mining and analysis, such as topic extraction algorithm, sentiment detection algorithm, and/or feature extraction algorithm. The system may further use open API framework for model integration.

In some embodiments, a method of facilitating product research and development, comprising: at a computing system having one or more processors and memory: obtaining respective product-related data from a plurality of data sources, including (1) respective product-specific data for a plurality of products, and (2) non-product-specific data including at least one of talent profile data of an industry corresponding to the plurality of products and technology description data for one or more technical areas related to the plurality of products; performing topic extraction on the respective product-specific data for a plurality of products and the non-product-specific data to obtain respective topics associated with the plurality of products and corresponding numerical statistics for the respective topics; performing sentiment analysis on the respective product-specific data for a plurality of products for the respective topics extracted from the respective product-specific data and the non-product-specific data, to obtain respective values of a measure of consumer sentiment corresponding to the respective topics for a respective product of the plurality of products; and presenting an integrated sentiment review of a selected product based on the respective values of the measure of consumer sentiment corresponding to one or more of the respective topics for the selected product.

In accordance with some embodiments, a computing system (e.g., a platform) or a device (e.g., a user device) includes one or more processors, and memory storing instruction, the instructions, when executed by the one or more processors, cause the processors to perform operations of any of the methods described herein. In accordance with some embodiments, a computer-readable storage medium (e.g., a non-transitory computer readable storage medium) is provided, the computer-readable storage medium storing one or more programs for execution by one or more processors of a voice control apparatus, the one or more programs including instructions for performing any of the methods described herein.

Various advantages of the present application are apparent in light of the descriptions below.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a block diagram illustrating an operating environment including a server system, a user device, and a plurality of data sources used for facilitating product research and development, in accordance with some embodiments.

FIG. 2 shows a block diagram of a data mining and analysis process for product research and development, in accordance with some embodiments.

FIG. 3 shows a block diagram of a data mining and analysis process for product research and development, in accordance with some embodiments.

FIG. 4 shows a flowchart illustrating a process for performing topic extraction and sentiment analysis, in accordance with some embodiments.

FIGS. 5A-5I illustrate examples of user interfaces for presenting integrated sentiment reviews to facilitate product research and development, in accordance with some embodiments.

FIG. 6 is a flowchart of a method of facilitating product research and development performed at a terminal device, in accordance with some embodiments.

FIG. 7 is a flowchart of a method of facilitating product research and development performed at a server system, in accordance with some embodiments.

FIG. 8 is a block diagram illustrating a server system for implementing the method for facilitating product research and development, in accordance with some embodiments.

FIG. 9 is a block diagram illustrating a terminal device for performing the method for facilitating product research and development and displaying various embodiments of the integrated sentiment reviews, in accordance with some embodiments.

Like reference numerals refer to corresponding parts throughout the several views of the drawings.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

The following clearly and completely describes the technical solutions in the embodiments of the present application with reference to the accompanying drawings in the embodiments of the present application. The described embodiments are merely a part rather than all of the embodiments of the present application. All other embodiments obtained by persons of ordinary skill in the art based on the embodiments of the present application without creative efforts shall fall within the protection scope of the present application.

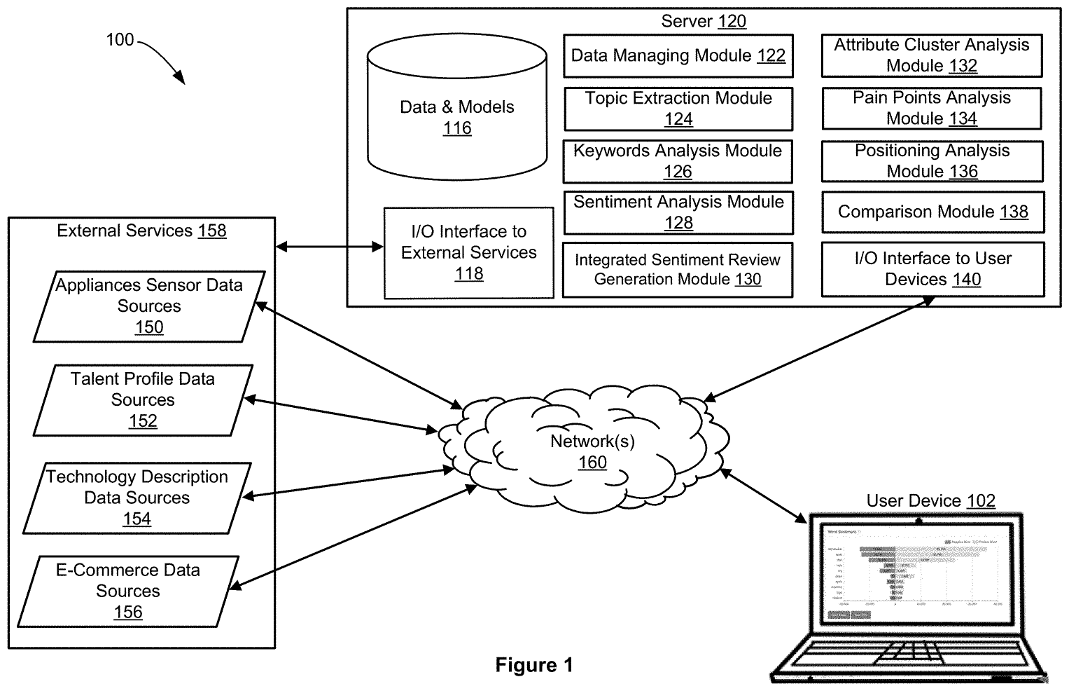

FIG. 1 is a block diagram illustrating an operating environment 100 including a server system 120, a terminal device (e.g., user device 102), and a plurality of data sources (e.g., external services 158) used for facilitating product research and development, in accordance with some embodiments. In some embodiments, the external services 158 include one or more appliances sensor data sources 150 (e.g., including appliance usage logs, maintenance logs, appliance operating system update logs, malfunction logs, trouble-shooting logs, etc.), one or more talent profile data sources 152 (e.g., job posting websites such as Indeed.com, Monster.com, professional profile websites such as LinkedIn), one or more technology description data sources 154 (e.g., patent information listed in patent database such as Google Patents, USPTO published patent information), and one or more e-commerce data sources 156 (e.g., such as consumer review data from online retailor websites such as Amazon, Walmart, Costco, sales and marketing data, etc.). In some embodiments, the terms related to a plurality of “data sources” refer to information processing systems or platforms that obtain data (e.g., sales data, marketing data, customer review data, appliance sensor data, talent acquiring information, patent information, etc.) from a plurality of users (e.g., individual users, corporate users, or other types of entity users), organize and store the obtained data, receiving user requests related to obtaining information from the stored data (e.g., obtaining appliance sensor data related to usage logs of the corresponding appliance) and/or performing tasks (e.g., starting an online chat session to report issues with purchased products, or sending a command to an appliance at a user's household in response to an error code received from a sensor installed on the appliance) based on the stored data, and executing corresponding operations in response to the received user requests.

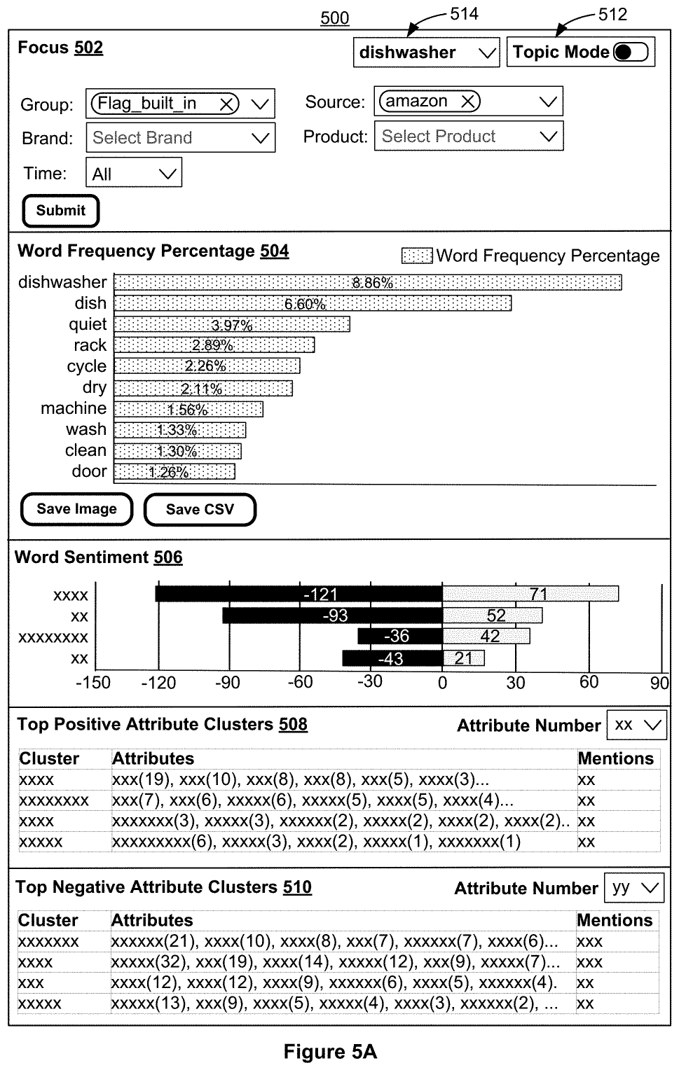

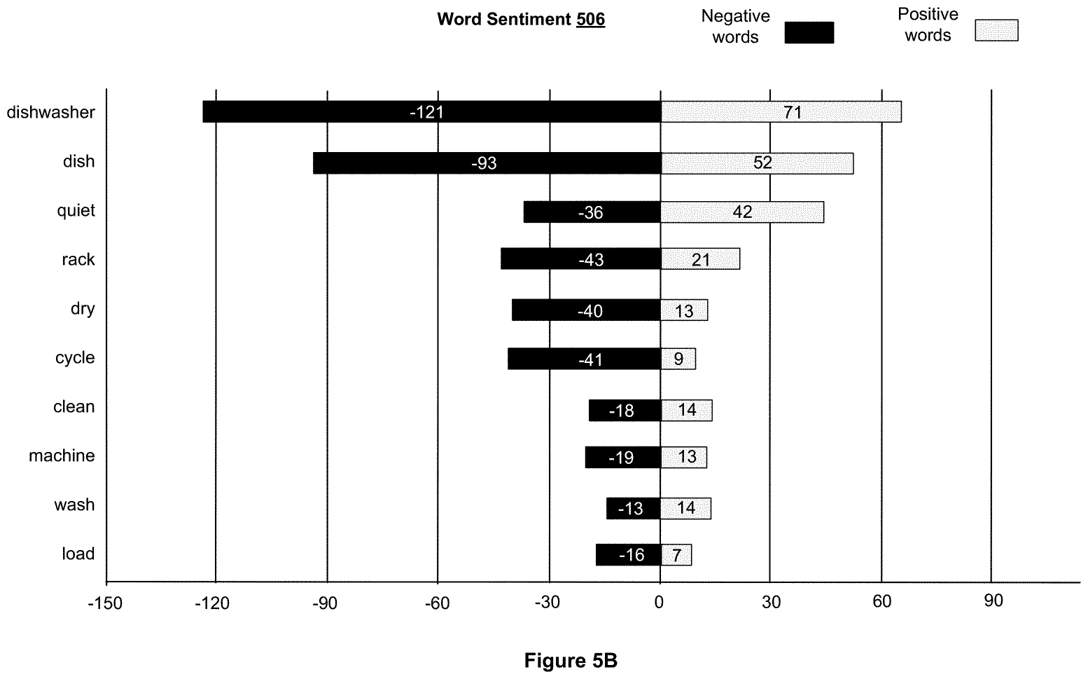

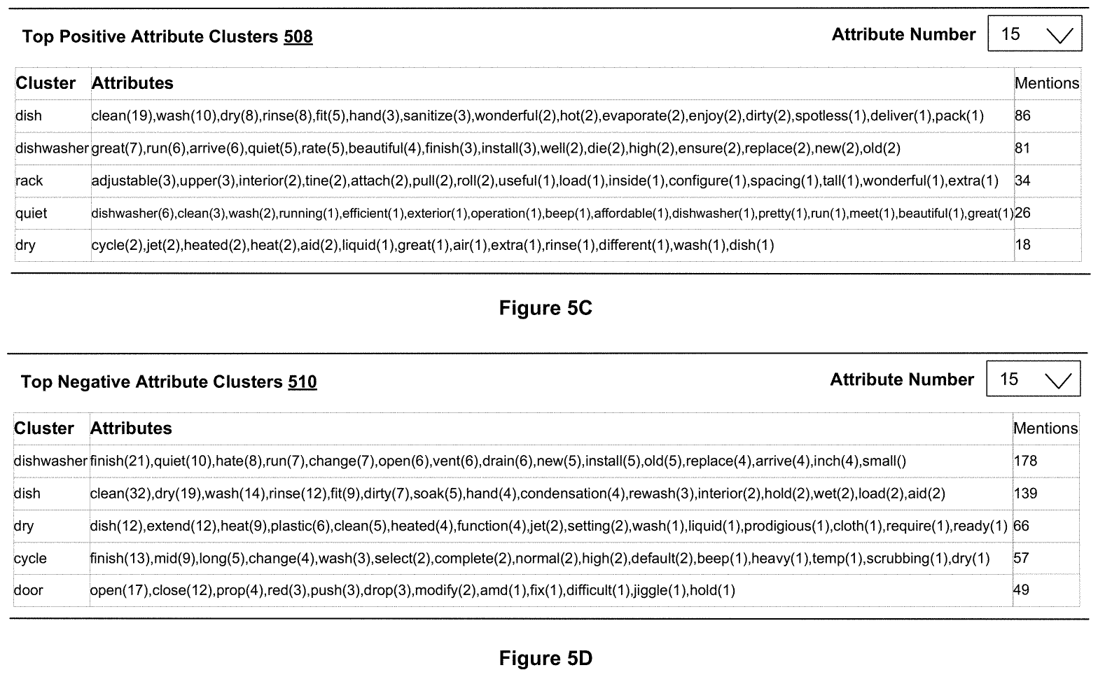

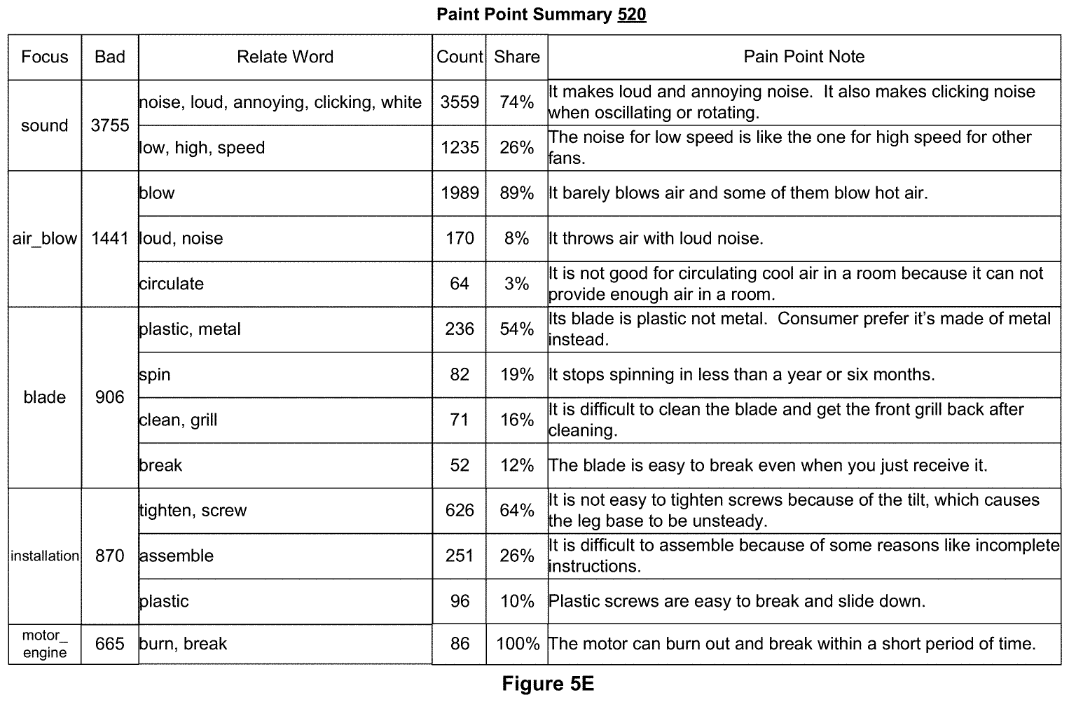

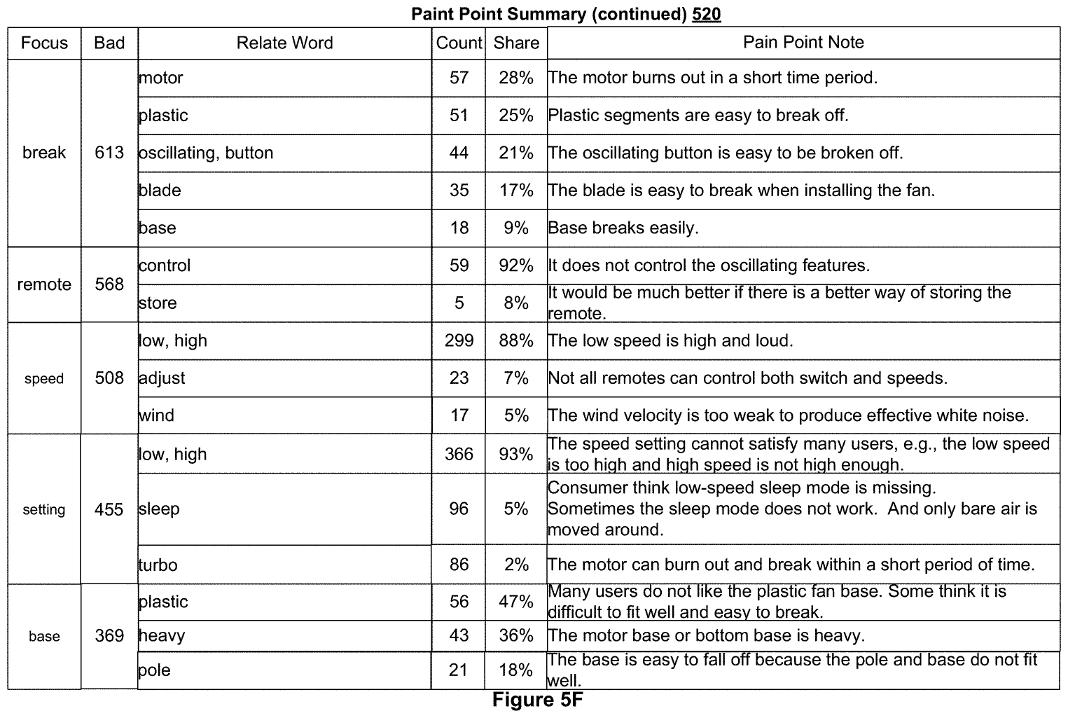

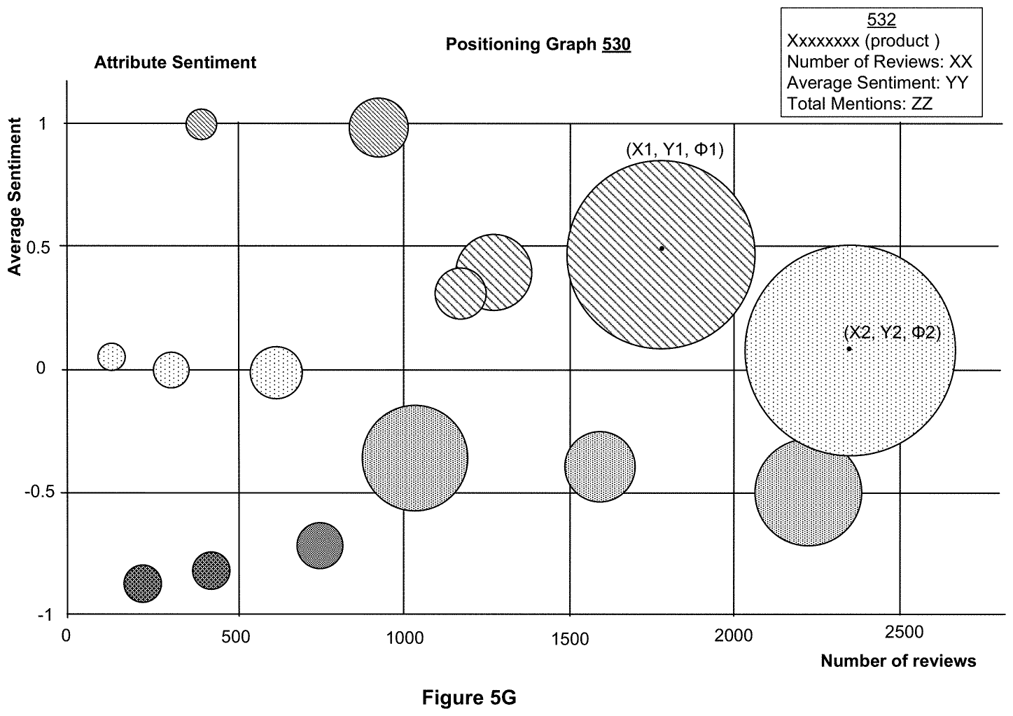

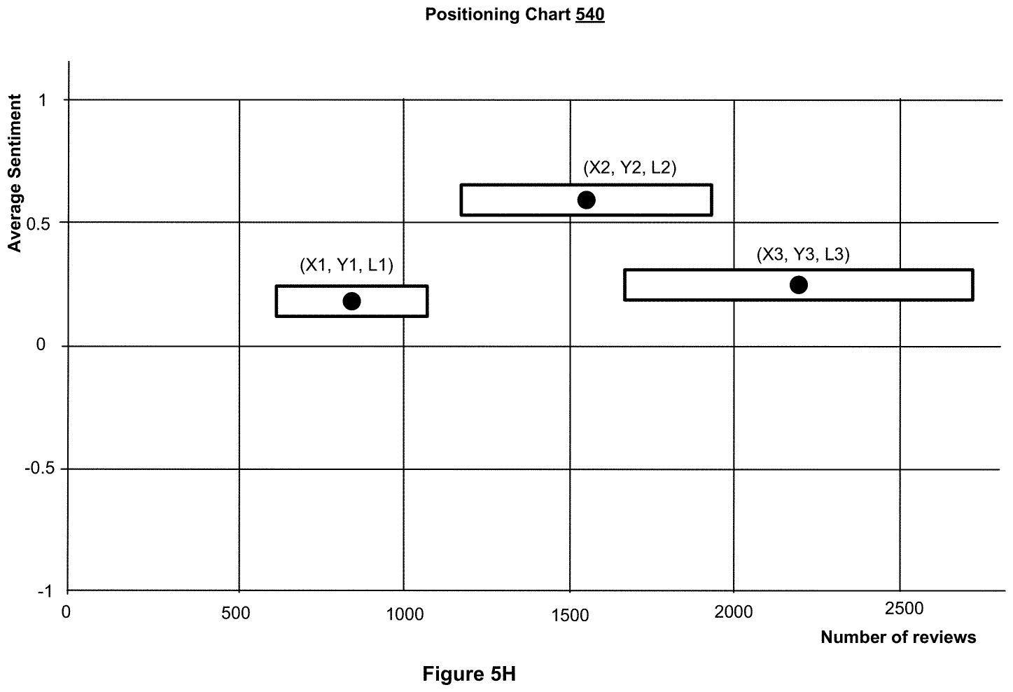

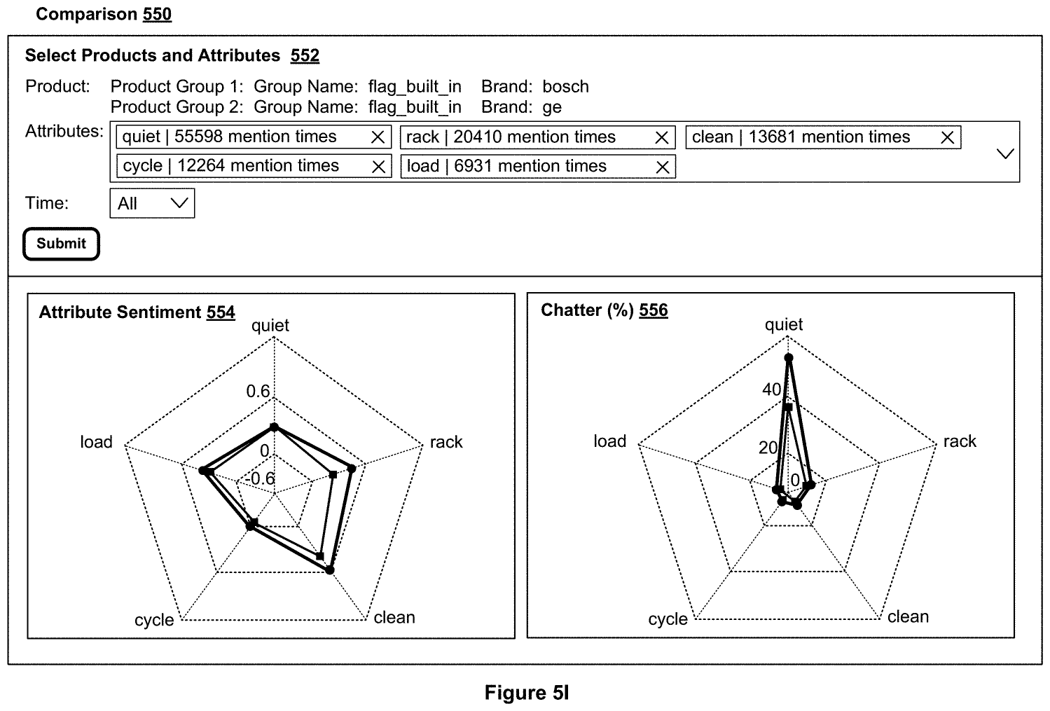

As shown in FIG. 1, in some embodiments, the system for facilitating the product research and development (hereinafter “the system”) is hosted by the server 120 and is implemented according to a client-server model. The system includes a client-side portion (e.g., modules) (e.g., illustrated in FIGS. 5A-5I) executed on a user device 102 (e.g., a laptop, a desktop, a smartphone, a tablet, or a central communication hub) that is deployed at various deployment locations (e.g., product design and producing sites, a user's home, a corporate office, etc.), and a server-side portion (e.g., the backend modules, the product research and development platform) executed on the server system 120. In some embodiments, the client-side portion executed on the user device 102 communicates with the server-side portion executed on the server system 120 through one or more networks 160. The user device 102 performs client-side functionalities such as receiving user requests related to product research and development, interacting with the server system 120, and receiving and outputting results in response to the user requests. The server system 120 provides server-side functionalities for any number of client devices (not shown) each residing on a respective user device (e.g., user devices registered for different corporate accounts or household accounts).

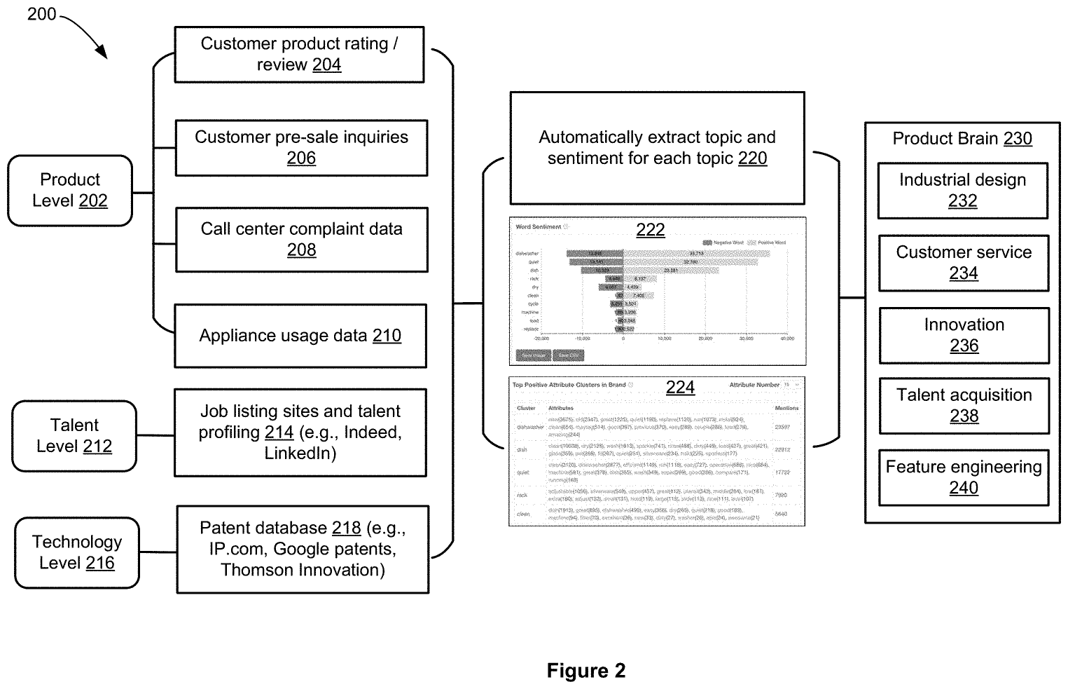

In some embodiments, the server system 120 includes one or more processing modules (e.g., data managing module 122, topic extraction module 124, keywords analysis module 126, sentiment analysis module 128, integrated sentiment review generation module 130, attribute cluster analysis module 132, pain point analysis module 134, positioning analysis module 136, and comparison module 138), one or more processors, one or more databases 116 for storing data (e.g., customer review data 204, customer pre-sale inquiries 206, call center complaint data 208, appliance customer usage data 210, job listing and talent profiling data 214, and patent data 218, FIG. 2) and models (e.g., topic extraction models, sentiment analysis models, feature extraction models, etc.), I/O interface 140 to one or more user devices 102, and an I/O interface 118 to one or more external services 158 (e.g., appliance sensor data sources 150, talent profile data sources 152, technology description data sources 154, and e-commerce data sources 156) on their individual computing systems. In some embodiments, the I/O interface 140 to client-side modules facilitates the client-side input and output processing for the client-side modules on respective user devices 102. In some embodiments, the one or more server-side modules utilize the various real-time data obtained through various internal and external services, real-time data received from the user devices (e.g., user reviews) and/or household appliances (e.g., sensor data), and existing data stored in the various databases, for performing data analysis to facilitate product research and development. In some embodiments, the server 120 communicates with external services 158 through the network(s) 160 for data acquisition. The I/O interface 118 to the external services 158 facilitates such communications.

Examples of the user device 102 include, but are not limited to, a cellular telephone, a smart phone, a handheld computer, a wearable computing device (e.g., a HMD), a personal digital assistant (PDA), a tablet computer, a laptop computer, a desktop computer, an enhanced general packet radio service (EGPRS) mobile phone, a media player, a navigation device, a game console, a television, a remote control, a point of sale (POS) terminal, vehicle-mounted computer, an ebook reader, an on-site computer kiosk, a mobile sales robot, a humanoid robot, or a combination of any two or more of these data processing devices or other data processing devices. As discussed with reference to FIG. 2B, a respective user device 102 can include one or more client-side modules that perform similar functions as those discussed in server-side modules 106. The respective user device 102 can also include one or more databases storing various types of data that are similar to the databases 130 of the server system 104.

Examples of one or more networks 110 include local area networks (LAN) and wide area networks (WAN) such as the Internet. One or more networks 110 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some embodiments, the external services 158 can be implemented on at least one data processing apparatus and/or a distributed network of computers. In some embodiments, the external services 158 also employs various virtual devices and/or services of third party service providers (e.g., third-party cloud service providers) to provide the underlying computing resources and/or infrastructure resources of the external services 158.

FIG. 2 shows a block diagram of a data mining and analysis process 200 for product research and development, in accordance with some embodiments. In some embodiments, the process 200 includes obtaining data related to products from a plurality of data sources, including product level data sources 202, talent level data sources 212, and technology level data sources 216. In some embodiments, the product level data sources 202 include customer product rating/review data 204 and customer pre-sale inquiries 206 that are obtained from one or more e-commerce providers (e.g., Amazon, Walmart, Costco, Target, etc.) and/or product review sites. For example, the customer product rating/review data 204 includes reviews from online and offline survey or interview, customer's questions/inquiries before they make the purchase. In some embodiments, the product level data sources 202 further include call center complaint data 208 (e.g., customer service call center feedback collections). In some embodiments, the product level data sources 202 further include appliance usage data 210, such as actual appliance usage data collected by one or more sensors integrated on one or more appliances in households. In some embodiments, Natural Language Processing (NLP) analysis and topic extraction analysis are used to process text reviews and identify feature focus, so as to explore the pros and cons of each feature to obtain a recommendation based on the reviews, inquiries, and/or complaints related to the product or brand.

As discussed above, only knowing the market responses to and user reviews of the products is not enough. A lot of conventional procedure ignored the importance of talent information. As such, applying NLP algorithm to extract technology focus (e.g., topics) from job listings and talents profiles online of an industry corresponding to the products, a company can plan ahead what skillset they need to build/invent the next generation products. In some embodiments, the talent level data source 202 includes job posting data from job listing sites (e.g., Indeed, Monster) or talent profile data 214 from professional profile platform (e.g., LinkedIn).

Technology innovation sometimes is what people planning to do, but what does the current technology stage stands is ignored by most of the conventional product mining procedures. Through mining filing and filed patents (e.g., by competitors in the market) on patent database 218 (e.g., IP.com, Google Patents, Thomson Innovation), the company can plan what area is still blank or needs to be improved.

In addition to obtaining the data related to the products from the plurality of data sources, the process 200 further includes automatically extracting (220) topics and perform sentiment analysis on the data to obtain the sentiment data for each extracted topic. In some embodiments, the product level data sources 202, talent level data sources 212, and technology level data sources 216 are associated with a large amount of unstructured data. The process 200 applies algorithms to accelerate the understanding of the contents being collected. For example, topic algorithm extracts topics which are the focus of the sentences in the data. In some embodiments, the topic extract algorithm is used to summarize customer feedback and patent analysis to identify a plurality of topics. In some embodiments, the sentiment algorithm is used to analyze the emotion (e.g., positive, neutral, or negative) of customers' feedbacks to understand the pros and cons of the underlying topic. In some embodiments, feature extraction is used to extract features from sentences and it is different from patent concept extraction and talents' skill set extraction.

In some embodiments, as shown in FIG. 2, after extracting a plurality of topics for a selected product, the system generates a word sentiment chart 222 (e.g., for display on a user device 102) that shows a volume of negative words and a volume of positive words that are compared side-by-side for each extracted topic. In some embodiments, the system further extracts sentiments (e.g., from user reviews, and including positive words, negative words, and neutral words) for each topic. The system further generates an attribute clusters 224 (e.g., for display on a user device 102). For example, as shown in FIG. 2, a positive attribute clusters in brand chart 224 lists a number (e.g., a user selected number, such as 15 in FIG. 2) of attributes (e.g., positive attributes) for each cluster (e.g., an extracted topic, or other word (e.g., under non-topic mode)) for each selected brand or selected product. In some embodiments, the system obtains a total number of mentions of a respective attribute word among all user reviews (e.g., 3675 for “new”, 2347 for “old”, etc.). The chart further includes a total number of mentions of each cluster word/topic word (e.g., a total times that the corresponding topic word or other type of word is mentioned in all user reviews, such as 23597 for “dishwasher”, 22912 for “dish”).

In some embodiments, the extracted topics, sentiment, and corresponding statistics and analysis can be used for various applications (e.g., “product brain” 230). For example, the extracted topics and corresponding user sentiment can be used for industrial design 232 (e.g., product design, function design, etc.) for a particular product (e.g., a dishwasher). In some embodiments, the analysis can also be used for customer service 234 (e.g., anticipating user experience based on the user complaints and user reviews, and design to improve product features and/or post-sale customer service in accordance with the anticipated user experience), innovation 236 (e.g., research and development related to innovative product features, designs, and/or customer services).

In some embodiments, the analysis can further be used for talent acquisition 238. For example, the topics words extracted from job postings and professional profiles 214 in the relevant fields (e.g., key dishwasher or other appliances manufacturers) can reveal the future trend of a product, as the industry will want to hire talents who have relevant knowledge and skills for the research and development of the product. For example, if extracted topic words from the talent data in the dishwasher field include “materials science,” “stainless steel,” “strength,” “industrial design,” the current research and development of dishwasher may focus on using advanced stainless steel materials, improving strength of the dishwasher components, and improving overall appearances and performances of the dishwasher based on current industrial design philosophy.

In some embodiments, the analysis can also be used for feature engineering 240 and innovation 236. For example, the topic words extracted from patent database 218 can identify the cutting edge technology and features related to a product. For example, if extracted topic words from the patent database for the dishwasher include “rack,” “design,” “clean,” “convenient,” the research and development of dishwasher may focus on improving rack design to provide convenient dish placement and clean washing result.

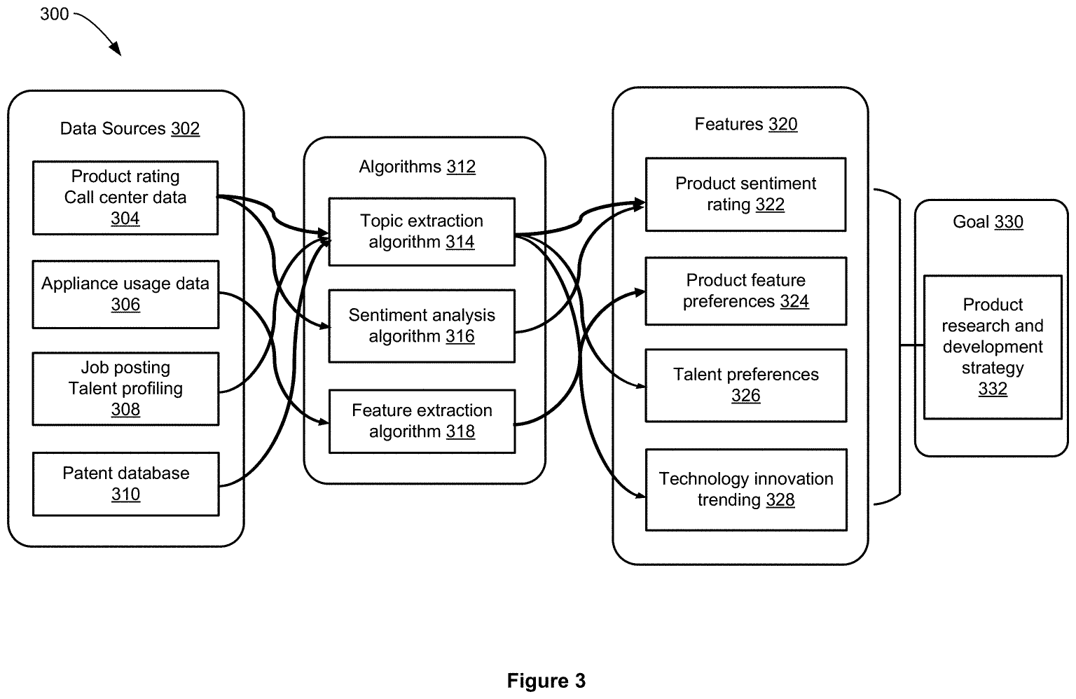

FIG. 3 shows a block diagram of a data mining and analysis process 300 for product research and development, in accordance with some embodiments. In some embodiments, one or more steps of the process 300 are performed by the server system 120. In some embodiments, the process 300 includes obtaining various types of data from data sources 302, including product rating data (e.g., customer reviews) and call center data (e.g., call center complaints) 304, appliance usage data 306 (e.g., appliance usage logs, maintenance logs detected from sensors), job posting and talent profiling data 308, and technical documents such as patent database 310.

In some embodiments, the server system 120 further applies a plurality of algorithms 312 (e.g., stored in the models 116, FIG. 1) to the different types of data obtained from various data sources 302. For example, the server system 120 applies the topic extraction algorithm 314 to the product review data and the call center customer complaint data 304 to extract topics from these data. In some embodiments, the extracted topics are not necessarily the most-frequently appeared keywords or some general high-level comments (e.g., “good”, “bad”, etc.). Instead, the server 120 uses the topic algorithm to extract topics that are the essential features of the product that are meaningful to the consumers (e.g., key features that are discussed in the customer reviews). For example, the topics extracted from the product rating/review data include “dish” “quiet” “rack” and “dry” which means that users emphasized their reviews of a dishwasher on features related to low noise level, usage features related to the rack, and whether the dishes can be efficiently and effectively dried. In some embodiments, the server system 120 may further train natural language processing (NLP) models to process human speech data (e.g., complaint data from the call center).

In some embodiments, the server system 120 applies the topic extraction algorithm 314 to the job posting data and the talent profiling data 308 so as to extract topic words related to the knowledge and skills required by the industry of a selected product. In some embodiments, the server system 120 also applies the topic extraction algorithm 314 to the patent database 310 to extract topic words from the patent documents that are related to the key technology and main future research and development trend in the industry of the selected product.

In some embodiments, the server system 120 applies the sentiment algorithm 316 to the product rating/review data and call center user complaint data 304 (e.g., after processing the speech data with the NLP algorithm) to obtain user sentiment for each topic. For example, the sentiment algorithm identifies positive, negative, and neutral words from the user review data and the complaint data for each topic, and counts the number of positive, negative, and neutral words for each topic.

In some embodiments, the server 120 further applies the feature extraction algorithm 318 to the appliance usage data 306. For example, key features of a product can be extracted from the appliance usage logs, maintenance logs, and/or error logs, such as “rack” “drain” etc.

In some embodiments, the server 120 obtains product features 320 from processing the data from the data sources 302 using the algorithms 312 as discussed above. In some embodiments, the product features include extract topics related to product feature preferences 324, talent preferences 326, technology innovation trending 328. The server also obtains product sentiment rating/reviews 322 by applying the sentiment algorithm 316 to the product rating/review data and the call center user complaint data 304.

In some embodiments, the server 120 uses the obtained features 320 to achieve a goal 330. For example, the goal 330 may be defined in a user request to receive a word sentiment chart 222 (FIG. 2), and the server 120 identifies the top-ranked topics and counts the positive and negative reviews for each top-ranked topic to present the word sentiment chart 222 to the user device 102. In some embodiments, the user request is related to identify product trending technology and designs to provide insights related to product research and development strategy 332. In response, the server 120 applies topic extraction algorithm 314 to the job posting data and talent profiling data 308, and patent database 310, to obtain topics related to the key terms revealed in the research and development of the product in the industry.

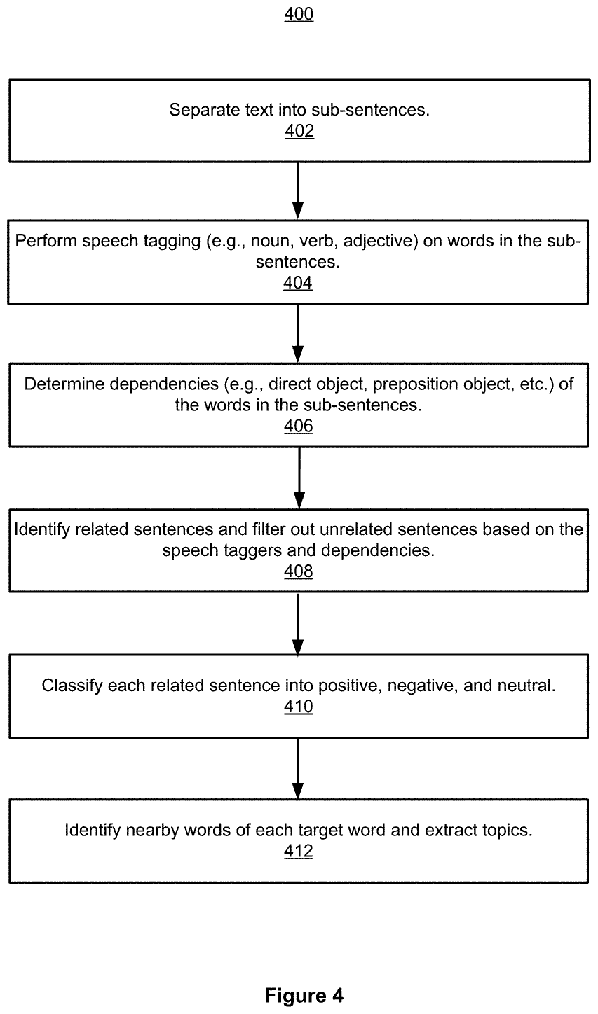

FIG. 4 shows a flowchart illustrating a process 400 for performing topic extraction and sentiment analysis, in accordance with some embodiments. In some embodiments, the process 400 starts from separating (402) the text into a plurality of sub-sentences. In some embodiments, each sub-sentence includes a plurality of words that are equal to or shorter than a full sentence. In some embodiments, the process 400 proceeds to perform (404) speech tagging on words in each sub-sentence. For example, the server 120 uses Long Short-Term Memory (LSTM) based models with a Conditional Random Field (CRF) layer to perform the speech tagging on the words and/or tokens in each sub-sentence to obtain speech tags such as a noun, a verb, or an adjective of a respective word. In some embodiments, the process 400 proceeds to determine (406) dependencies of the words in each sub-sentence. In some embodiments, the server 120 applies a dependency parser to give each word its relationship in the sentence. For example, the output of the dependency parser on a word includes one of “subj” (subject), “root” (root of the clause), “dobj” (direct object), “pobj” (object of preposition), “xcomp” (an open clausal complement), and other suitable dependencies. In some embodiments, the process 400 proceeds to identify (408) related sentences (or sub-sentences) and filter out unrelated sentences (or sub-sentences) based on at least the speech taggers and dependencies. In some embodiments, the process 400 proceeds to classify (410) each related sentence into positive, negative, and neutral. For example, the server uses a (Bidirectional Encoder Representations from Transformers) BERT classifier (e.g., at a learning rate of 0.0000035, a batch size of 64, a maxlen of 50) to classify each related sentence with a probability of 0-1. A score that is closer to 1 means highly positive, a score between 1 and 0.5 means positive, a score around 0.5 means neutral, a score between 0.5 and 0 means negative, and a score closer to 0 means highly negative. In some embodiments, the server further identifies (412) nearby words (e.g., using a window size of 2) of each target word to determine the context of each target and to evaluate the extracted topics for each sentence. In some embodiments, the process 400 applies a plurality of assumptions, such as the topics of the texts are related to the subject in each sentence; and the subject of a sentence is either a noun or a verb. In some embodiments, the process 400 applies a plurality of rules, such as if a word tag of a word is Noun and if the word is among a subjective word, a direct object (dobj), a preposition (pobj) and its object, then the word is determined to be a topic word. Another example of a rule includes if a word tag of a word is Verb, and if the word is among root and an open clausal complement (xcomp), then the word is determined to be a topic word.

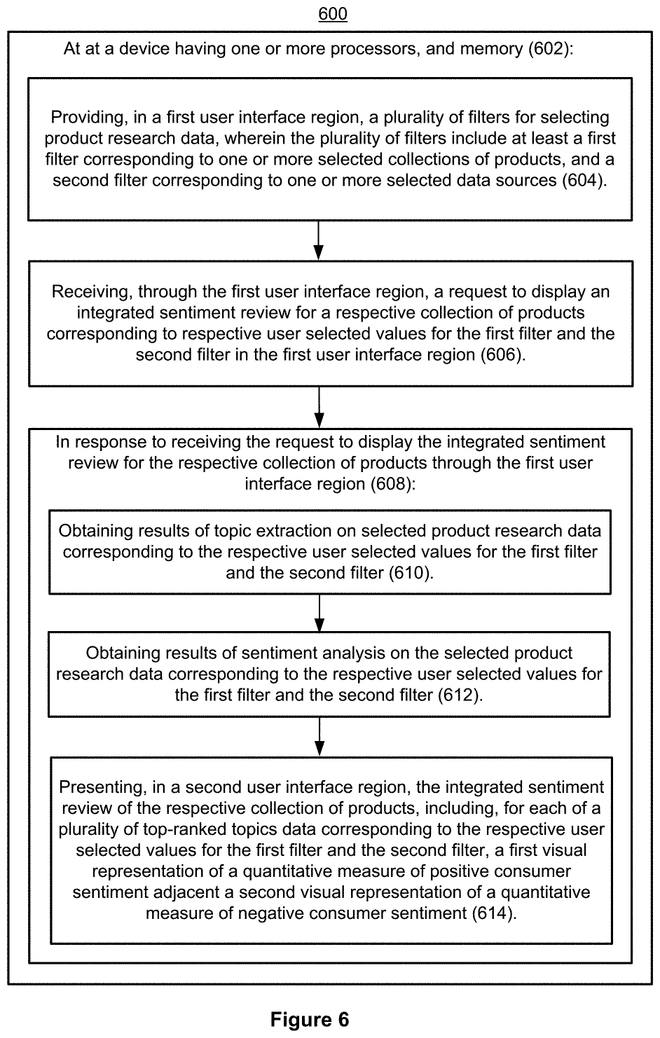

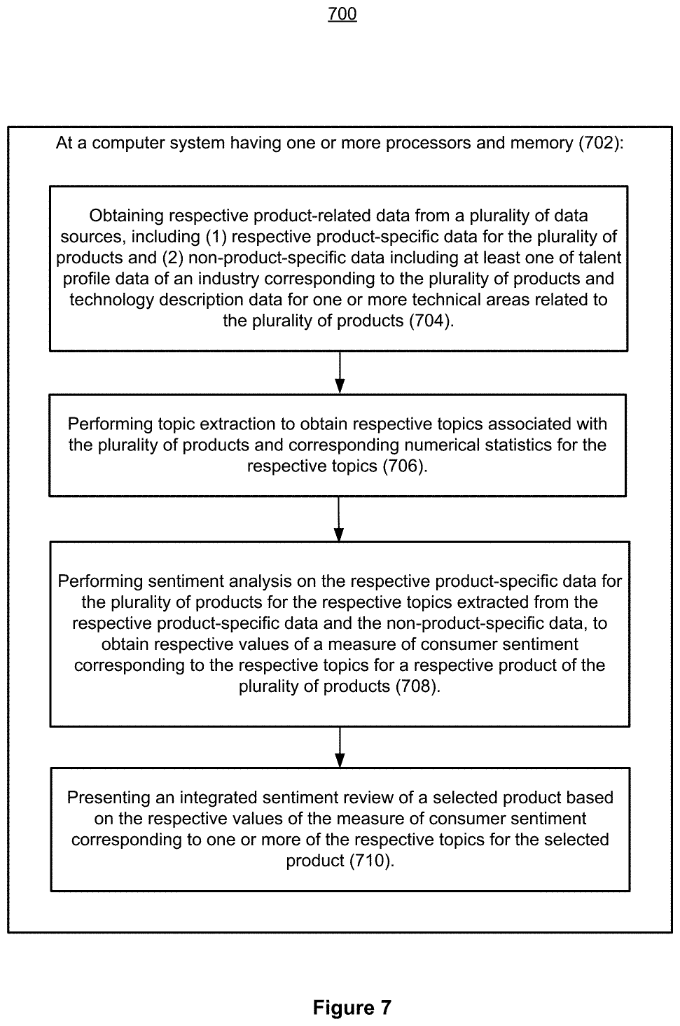

FIGS. 5A-5I illustrate examples of user interfaces for presenting integrated sentiment reviews to facilitate product research and development, in accordance with some embodiments. In some embodiments, the client-side functionalities of the methods 600 and 700 as discussed with reference to FIGS. 6 and 7 respectively are implemented on the user device 102, and the user interfaces of the integrated sentiment reviews are displayed on the user device 102.

FIG. 5A shows a user interface 500 including a first user interface region, i.e., the “Focus” user interface 502, for presenting a plurality of filters for selecting product research data and one or more integrated sentiment reviews in accordance with the user selections. In some embodiments, the plurality of filters are presented as a plurality of drop-down menus, including a “Group” menu for selecting a group of product for generating the integrated sentiment review, such as a type of product or a brand of product. In some embodiments, the plurality of filters also include a drop-down menu for selecting a “Source” corresponding to a data source for obtaining topics and sentiment to present the integrated sentiment review. In some embodiments, the data source is selected from the product-specific data and the non-product specific data discussed with reference to FIGS. 2-3 and 6-7 of the present disclosure. For example, the user may select a particular e-commerce platform (e.g., “Amazon”) for obtaining the product-specific data for conducting the data analysis and presenting the integrated sentiment review. In some embodiments, the plurality of filters further include drop-down menus such as a “Brand” menu for selecting product(s) of a particular brand, a “Product” menu for selecting a particular type of product (e.g., a dishwasher), and a “Time” menu for selecting data corresponding to a particular time period (e.g., the past three months, the past six months, the past one year, etc.) to conduct the data analysis and present the integrated sentiment review. In some embodiments, the user interface 500 further includes a drop-down menu 514 for selecting a type of product, such as “dishwasher” as shown in FIG. 5A.

In some embodiments, the user interface 500 further includes a “Topic Mode” selection affordance 512 (e.g., the toggle switch as shown in FIG. 5A) for switching between a topic mention mode and a pure word mention mode. In some embodiments, the topic mention mode corresponds to using the topic extraction algorithm as discussed in the present disclosure to identify topics from the selected product research data. In some embodiments, the “Focus” is more relevant to the consumer's focus on the key features and metrics of a certain product. In some embodiments, the pure word mention mode corresponds to identifying words with the highest occurrence rates in the selected product research data.

In some embodiments, the topic extraction for the “Focus” 502 can be based on a specific sub-category of products, a particular online channel for selling a type of product, a brand of product, or a particular type of product, based on the user selection of the plurality of filters on the user interface 500. In some embodiments, under the “Topic Mode”, a number (e.g., N) of top/most-frequently mentioned aspects obtained from the topic extraction process will be presented, indicating what focus consumer care most in their feedback.

In some embodiments, after receiving user selections of one or more options from the plurality of drop-down menu filters, and upon receiving a user interaction with the “Submit” button on the “Focus” user interface 502, the system receives a request to display an integrated sentiment review. For example as shown in FIG. 5A, the system uses topic extraction algorithm (e.g., FIG. 3) to extract a plurality of topics from the selected research data that is selected based on the user input of the filters on the user interface 500. As shown in the “Word Frequency Percentage” user interface 504, the system further lists top ten most-frequently mentioned topics, including “dishwasher”, “dish”, “quiet”, “rack”, “cycle”, “dry”, “machine”, “wash”, “clean”, and “door”. In some embodiments, the “Word Frequency Percentage” user interface 504 further presents a plurality of visual representations (e.g., bars) corresponding to the top ten topics respectively, where a dimension (e.g., a length) of each visual representation corresponds to a frequency of the corresponding topic mentioned among all extracted topics. For example, as shown in the “Word Frequency Percentage” user interface 504 of FIG. 5A, the most-mentioned topic “dishwasher” is presented with the longest bar and labeled as “8.86%”, indicating that the mention time of the topic “dishwasher” occupies 8.86% of all mention times for all extracted topics from the selected research data. Following the most mentioned topic “dishwasher”, the second most-mentioned topic “dish” is associated with a second longest bar, and labeled as “6.60%”, indicating that the mention time of the topic “dish” occupies 6.60% of all mention times for all extracted topics from the selected research data. The third most-mentioned topic “quiet” is associated with a third longest bar and labeled as “3.97%”, indicating that the mention time of the topic “quiet” occupies 3.97% of all mention times for all extracted topics. The fourth most-mentioned topic “rack” is associated with a fourth longest bar and labeled as “2.89%”, indicating that the mention time of the topic “rack” occupies 2.89% of all mention times for all extracted topics. The fifth most-mentioned topic “cycle” is mentioned 2.26% of all mention times for all extracted topics, the sixth most-mentioned topic “dry” is mentioned 2.11% of all mention times for all extracted topics, the seventh most-mentioned topic “machine” is mention 1.56% of all mention times for all extracted topics, the eighth most-mentioned topic “wash” is mentioned 1.33% of all mention times for all extracted topics, the ninth most-mentioned topic “clean” is mentioned 1.30% of all mention times for all extracted topics, and the tenth most-mentioned topic “door” is mentioned 1.26% of all mention times for all extracted topics. In some embodiments, the “Word Frequency Percentage” user interface 504 further provides a “Save Image” button for user to obtain an image of the generated graph, and a “Save CSV” button for user to obtain a spreadsheet document including the extracted topics and their associated statistics.

In some embodiments, the system further presents an integrated sentiment review including a “Word Sentiment” user interface 506 as shown in FIGS. 5A-5B for visually presenting user sentiment (e.g., comparing the positive and negative sentiment) obtained from the customer rating/review data for each top-ranked topic (e.g., the top-ranked topic that the consumers mainly focus on). In some embodiments, for a respective top-ranked topic, such as the most-mentioned topic “dishwasher”, a first visual representation of a quantitative measure of positive consumer sentiment (e.g., a light bar graph with a length corresponding to a total number of positive reviews on the topic “dishwasher” as labeled in “71”) is displayed adjacent a second visual representation of a quantitative measure of negative consumer sentiment (e.g., a dark bar graph with a length corresponding to a total number of negative reviews on the topic “dishwasher” as labeled in “121”) to contrast the positive and the negative sentiment from the user review data for a respective topic for the selected product. As shown in FIG. 5B, the second most-mentioned topic “dish” is mentioned 52 times in positive reviews and 93 times in negative reviews. The third most-mentioned topic “quiet” is mentioned 42 times in positive reviews and 36 times in negative reviews. Similar bar graphs contrasting the positive and negative mentions of each topic word are illustrated in the “Word Sentiment” user interface 506 in FIG. 5B. Such bar graphs provide intuitive visual representations to the user to show the customer sentiment feedbacks for each topic.

In some embodiments, the system further presents “Top Positive Attribute Clusters” 508 and “Top Negative Attribute Clusters” 510 as shown in FIGS. 5A and 5C-5D. In some embodiments, the “Top Positive Attribute Clusters” 508 show a plurality of topic words (e.g., “dish”, “dishwasher”, “rack”, “quiet”, “dry”) each corresponding to a “cluster”, and a number of attributes corresponding to each topic (e.g., “clean”, “wash”, “dry”, etc.). In some embodiments, the number of attributes for each topic is defined by the user, as the user can select a number from the drop-down “Attribute Number” menu (e.g., “15” attributes for each topic as shown in FIG. 5C). In some embodiments, the attributes correspond to user's positive sentiment that are obtained from user's review data. In some embodiments, the attributes listed for each cluster in the “Top Positive Attribute Clusters” 508 correspond to the words that are most frequently mentioned (e.g., top 15 most mentioned words from the positive reviews for each topic). In some embodiments, each attribute word is accompanied with an occurrence frequency count (e.g., for cluster “dish”, 19 for “clean”, 10 for “wash”, and 8 for “dry”, etc.) associated with the co-occurrence of the attribute word and the representative word for the selected topic corresponding to the respective positive cluster. In some embodiments, for each cluster, the “Top Positive Attribute Clusters” 508 further present a total number of mentions of the topic word for the cluster, such as “86” for “dish”, “81” for “dishwasher”.

In some embodiments, similar to the “Top Positive Attribute Clusters” 508, the “Top Negative Attribute Clusters” 510 list a plurality of topics/clusters (e.g., “dishwasher”, “dish”, “dry”, “cycle”, “door”), and a pre-defined (e.g., “15” for the Attribute Number) number of attributes corresponding to each cluster. In some embodiments, the attributes listed for each cluster in the “Top Negative Attribute Clusters” 510 correspond to the words that are most frequently mentioned (e.g., top 15 most mentioned words from the negative reviews for each topic). In some embodiments, each attribute word is accompanied with an occurrence frequency count (e.g., for cluster “dishwasher”, 21 for “finish”, 10 for “quiet”, and 8 for “hate”, etc.). In some embodiments, for each cluster, the “Top Negative Attribute Clusters” 510 further present a total number of mentions of the topic word for the cluster, such as “86178 for “dishwasher”, “139” for “dish”.

In some embodiments as shown in FIGS. 5E-5F, based on user's choice, a number N of top-mentioned negative aspects (e.g., obtained from the “Focus” field 502, such as from the “Word Sentiment” 506) will be populated with negative review count to form a part of a “Pain Point Summary” 520. This can indicate what particular aspects the consumers are talking negatively about a certain functionality or feature of the product. As shown in FIGS. 5E-5F, for each top-mentioned negative topic listed under “Focus” in the table, a total number of negative reviews/mentions is presented under “Bad”. In some embodiments, one or more sets of most-mentioned words are listed under “Related word”, such as a set of “noise” “loud” “annoying” etc. and a set of “low” “high” “speed” for “sound”. A total count of the mention times for each set of words are listed under “Count” and a percentage of the mention times is calculated and listed under “Share”. In some embodiments, one or more example negative reviews are presented in the “Pain Point Note” as supporting information. The selected example negative reviews help the user to conveniently understand the extracted words and topics in the original context, so as to understand the exact features concerned by the users and the particular sentiment the users have related to the features. In some embodiments, the “Pain Point Note” presents the top-ranked negative reviews, and the ranking is calculated by:

OverallPaintPointNoteRank=focusWordSentimentScore* wtᵢ+relationStrength*wtⱼ

In some embodiments as shown in FIGS. 5G-5H, a multi-dimensional metrics, such as a “Positioning” graph 530 or a “Positioning” chart (e.g., bar chart) 540 are presented as a type of integrated sentiment review. In some embodiments, the “Positioning” graph shows various quantitative measures of the best performing products when analyzing one specific topic (e.g., a user selected topic). As shown in FIG. 5G, in some embodiments, the positioning graph 530 includes a plurality of circles each of which represents a plurality of characteristics of a certain product via its dimensions. For example, the diameter (Φ) of a circle corresponds to a total number of mentions for the underlying topic for the corresponding product, the X coordinate of the center of the circle corresponds to a number of reviews based on the underlying topic for the corresponding product, and a Y coordinate of the center of the circle corresponds to an average sentiment value (e.g., positive value for positive sentiment, negative value for negative sentiment) based on the underlying topic for the corresponding product. As such, a circle/bubble flows towards the top indicates the better reviews consumer mentioned in the feedbacks (e.g., more positive sentiment). In some embodiments, the “Positioning” graph 530 can be used for showing best performing product(s) or best performing brand(s) when analyzing a particular topic (e.g., providing a switching affordance on the user interface for the user to select between best performing product(s) and best performing brand(s)).

For example as shown in the Positioning Graph 530 in FIG. 5G, the user may choose “wash” as a function feature. For the bubble that floats more toward the top of the graph (e.g., with a greater/more positive Y value), the sentiment for that particular product or brand is more positive in the aspect related to the feature “wash”. Further, a bigger bubble (e.g., with a greater 1 value) represents more topic mentions for the word “wash” for the corresponding product or brand. In addition, for a bubble that floats more toward right of the graph (e.g., with a greater X value), the corresponding product receives more reviews and can be seen as a popular product. In some embodiments, a product/brand corresponding to a circle with a bigger diameter and located more toward the upper right direction of the chart indicate a better performing product. Thus the Positioning Graph 530 can provide a more efficient and intuitive method for the user to identify the best performing product/brand.

In some embodiments, the circles are further filled with different colors and/or patterns. In some embodiments, the circle(s) for the product(s) with positive average sentiment are filled with green color or line pattern, whereas the circle(s) for the product(s) with negative average sentiment are filled with red color or dot pattern. In one example, the more positive the sentiment value is, the corresponding circle is filled with redder color or more dense lines; and the more negative the sentiment value is, the corresponding circle is filled with greener color or more dense dots. As such, the colors or patterns of the circles are used to provide more straightforward and intuitive visual experience for the user to view which product(s) is/are the best performing product(s) for the underlying topic. In some embodiments, the color or pattern of each circle can further represent an additional dimension/characteristic of the corresponding product. In some embodiments, the objects in the Positioning Graph 530 can be presented in 3-dimensional to illustrate other dimension(s)/characteristic(s) of the corresponding product. In some embodiments, when the user selects or interacts with a circle (e.g., X1, Y1, Φ1), the corresponding respective values of the quantitative measures of the characteristics are shown in a text box 532 in the positioning graph 530, such as product features (e.g., dimensions), number of reviews, average sentiment, and total mentions, etc. In some embodiments, additional characteristic of the product considered includes the year of release. For example, although a smaller circle and/or located more toward the right of the chart generally indicates that the corresponding product received less mentions/reviews (e.g., due to less sales number, and/or less relevant to the underlying topic), if the product was released fairly recently, it may indicate that the product such topic feature is more innovative/modern (thus receiving less reviews). However, if the product has been released for many years and not considered as a new product, smaller circle and/or located more toward the right of the chart may indicate that the product is not popular in the market thus may not be considered as a successful product.

In another example as shown in FIG. 5H, the “Positioning Chart” 540 is an alternative visual representation showing similar content as the Positioning Graph 530. For example, if the user chooses “wash” as a function feature, for a bar that floats more toward the top of the chart (e.g., with a greater Y coordinate), the sentiment for that particular product or brand is more positive in the aspect related to the feature “wash”. Further, a longer bar (e.g., with a greater L coordinate) represents more topic mentions for the function word “wash” for the corresponding product or brand. In addition, for a bar that floats more toward right of the graph (e.g., with a greater X coordinate), the corresponding product receives more reviews and can be seen as a popular product.

In some embodiments as shown in FIG. 5I, a “Comparison” user interface 550 can be presented to compare attribute sentiment values and numbers of reviews that mention respective attribute words between groups of products, brands, individual products, or different website sources regarding certain feature(s). In some embodiments, the “Comparison” user interface 550 provides a plurality of parameters that can be selected by the users to perform the comparison. For example, the user can select two groups of products corresponding to a group of built-in dishwasher by “Bosch” and a group of built-in dishwasher by “GE”. In some embodiments, the user further selects a number of attribute words (e.g., quiet, rack, clean, cycle, load, etc.). In some embodiments, in response to the user selection of an attribute word, the mention times of the corresponding attribute word is displayed, such as 55598 mention times for “quiet” and 20410 mention times for “rack”. In some embodiments, the user can further define the time period associated with the product research data.

In response to the user selection of the “Submit” button, the system performs related data analysis, and presents the “Attribute Sentiment” graph 554, and the “Chatter” graph 556. In some embodiments, the “Attribute Sentiment” graph 554 shows an average sentiment score for each attribute word for each selected group of product. The “Attribute Sentiment” graph 554 compares the overall feedback sentiment summary for the underlying attributes between groups. In some embodiments, the “Chatter” graph 556 is presented side-by-side with the “Attribute Sentiment” graph 554 as shown in FIG. 5I. In some embodiments, the “Chatter” graph 556 shows a percentage of total reviews that mention the underlying attribute word. In some embodiments, the “Chatter” graph 556 compares the popularity mentioned in the reviews for underlying attributes between groups.

FIG. 6 is a flowchart of a method 600 of facilitating product research and development, in accordance with some embodiments. The method is performed at (602) a computing system (e.g., the client-side functions on the user device 102) having one or more processors and memory. In some embodiments, the method 600 includes providing (604), in a first user interface region (e.g., the “Focus” user interface 502, FIG. 5A), a plurality of filters (e.g., multi-selection drop-down menus of selectable options) for selecting product research data. In some embodiments, the plurality of filters include at least a first filter corresponding to one or more selected collections of products (e.g., a “group” of related products, a type of product, a brand of products, etc.), and a second filter corresponding to one or more selected data sources. In some embodiments, the “data sources” includes (1) respective product-specific data and (2) non-product specific data for a plurality of products. In some embodiments, the respective product-specific data includes: (a) consumer review data of a category of products (e.g., a category of appliances, cosmetics, electronics, clothing, or furniture, etc.) or one or more related category of products (e.g., categories corresponding to various types of kitchen appliances, various types of home appliances, various types of clothing, or various types of furniture, etc.), and (b) product usage data of a category of products or one or more related categories of products (e.g., feedback or usage logs transmitted from the appliances (e.g., detected by sensors), sales reports from sellers and distributors, sales report transmitted from e-commerce portals, etc.). In some embodiments, a category of product corresponds to a specific type of product that is associated with a brand and a model, e.g., a dishwasher of Model #aaa manufactured by AAA company. In some embodiments, the consumer review data includes consumer comments provided on online portals, market surveys, pre-sale inquiries, customer support calls, product research results, etc., and the product usage data includes statistics for sales, usage frequencies, customer call frequencies, etc. for each product, category of products, or related categories of products. In some embodiments, the consumer review data takes the form of textual content in natural language, ratings, and the product usage data take the form of statistics, electronic logs. In some embodiments, the non-product specific data includes at least one of talent profile data of an industry corresponding to the plurality of products (e.g., including job posting data published by one or more industry players (e.g., manufacturers and distributors of the plurality of products) and technology description data for one or more technical areas related to the plurality of products (e.g., published patents and publications, academic papers, industry conference proceedings, industry white papers, etc.).

In some embodiments, the method 600 further includes receiving (606), through the first user interface region, a request to display an integrated sentiment review for a respective collection of products corresponding to respective user selected values for the first filter and the second filter in the first user interface region. For example as shown in FIG. 5A, the user clicking on the “submit” button on the “Focus” user interface, after having selected one or more options under at least one of the Group, Brand, Product filters, and one or more options under the Source filter.

In some embodiments, in response to receiving the request to display the integrated sentiment review for the respective collection of products through the first user interface region (608): the method 600 further includes obtaining (610) results of topic extraction (e.g., using clustering and topic extraction models and algorithms to process the respective product-related data from a plurality of data sources) on selected product research data corresponding to the respective selected values for the first filter and the second filter. In some embodiments, the selected product research data includes the respective product-specific data for a plurality of products (e.g., the review data of the products from online portals, ecommerce websites, etc.) and the non-product-specific data (e.g., the job posting data, and the patent data for the industry and technical areas related to the plurality of products). In some embodiments, the method 600 includes obtaining respective topics associated with the respective collection of products and corresponding numerical statistics for the respective topics (e.g., frequency count, percentage of occurrences, etc.).

In some embodiments, the method 600 further includes obtaining (612) results of sentiment analysis on the selected product research data corresponding to the respective selected values for the first filter and the second filter. In some embodiments, results of sentiment analysis on the respective product-specific data for a plurality of products (e.g., the review data of the products from online portals, ecommerce web sites, etc.) for the respective topics extracted from the respective product-specific data and the non-product specific data corresponding to the respective collection of products) include respective values of a measure of consumer sentiment (e.g., respective statistics (e.g., frequency count, percentage of occurrences, etc.) of positive sentiment and negative sentiment) corresponding to the respective topics for the respective collection of products).

In some embodiments, the method 600 further includes presenting (614), in a second user interface region, the integrated sentiment review of the respective collection of products. In some embodiments, presenting the integrated sentiment review includes, for each of a plurality of top-ranked topics (e.g., top-ranked topics are distinct from the words with the highest occurrence rates in the selected product research data) in the results of topic extraction on the selected product research data corresponding to the respective selected values for the first filter and the second filter, a first visual representation of a quantitative measure of positive consumer sentiment adjacent a second visual representation of a quantitative measure of negative consumer sentiment (e.g., a bar graph contrasting the total number of positive vs. negative reviews for a respective topic for the respective product).

In some embodiments, as shown in the word sentiment chart 506 in FIGS. 5A-5B, the first visual representation of the quantitative measure of positive consumer sentiment for a respective topic of the plurality of top-ranked topics is labeled by a respective represented word (e.g., attribute words “quiet”) corresponding to the respective topic and the first visual representation is displayed with a visual characteristic (e.g., length and a numerical value) corresponding to a respective frequency (e.g., “Quiet, positive word: 42) that the representative word (e.g., the word “quiet” and optionally including its variants) occurs in a first subset of the selected product research data that corresponds to the respective topic with positive consumer sentiment. In some embodiments, the selected product research data that included the representative word are not all focused on the topic, so a total word frequency for the representative word is not an accurate measure of the amount of true relevant data available for the topic. In some embodiments, the respective frequency does not include all occurrences of the representative word in a second subset of the selected product research data that has positive consumer sentiment. In some embodiments, some sentences may include the word “quiet” and has a positive sentiment, but the sentences may not be about the topic labeled “quiet” for the selected collection of products. For example, the word “quiet” is just mentioned in passing in the sentences (e.g., in a sentence “Although my daughter is pretty quiet about it, she didn't hide the fact that she liked this product.), then the sentence is not a sentence that focus on the topic “quiet”, and the word “quiet” in this sentence is not a topic word, and the first frequency does not count this occurrence of the word “quiet” for this product.). In some embodiments, the second visual representation for the respective topic is displayed with a second visual characteristics (e.g., length and a numerical value corresponding to the negative consumer sentiment for the respective topic “quiet”) corresponding to a respective frequency “36” that the representative word “quiet” and variants occurs in a third subset (e.g., may or may not overlap with the first and second subsets associated with the first visual representation) of the selected product research data corresponding to the respective topic with negative consumer sentiment, which may not include all occurrences of the representative word in a fourth subset of the selected product research data that has negative consumer sentiment. For example, reviews that include “quiet” not as a topic of the sentence, but has a negative sentiment; “nothing really stands out (good or bad), I'd rather stay quiet about it.”) this is not counted in the frequency. In some embodiments, the second visual representation of the quantitative measure of negative consumer sentiment is displayed adjacent the corresponding first visual representation for the respective topic (“quiet”) and labeled by the respective represented word. For example, the respective topic word is displayed on the Y-axis, one end of the first representation is in contact with one end of the second visual representation; a length of the respective visual representation is proportional to the corresponding frequency, and marked with the corresponding numerical value.

In some embodiments, as shown in the top positive/negative attribute clusters 508 and 510 in FIGS. 5A-5B, the method 600 further includes displaying, in a third user interface region (e.g., region showing “top positive attribute clusters”), one or more positive clusters (and optionally, one or more negative clusters). In some embodiments, a respective positive cluster of the one or more positive clusters is labeled with a representative word of a selected topic (e.g., “quiet”) corresponding to the respective positive cluster, and with a plurality of attribute words (e.g., dishwasher, clean, wash, etc.) that occurred in the same context (e.g., focused on the same topic in the same segment of product research data) as the representative word of the selected topic corresponding to the respective positive cluster. In some embodiments, each attribute word is accompanied with an occurrence frequency count (e.g., 6 for dishwasher, 3 for clean, and 2 for wash, etc.) associated with the co-occurrence of the attribute word and the representative word for the selected topic corresponding to the respective positive cluster. In some embodiments, the each cluster is displayed with a count of a total occurrences of the representative word for the selected topic with a positive sentiment (e.g., “26 mentions) in the selected product research data. In some embodiments, the user can specifies an attribute count (e.g., attribute number=3, 5, 15, etc.), and only the top-ranked attribute words (e.g., top 3, 5, 15, etc.) for a respective cluster (e.g., words that most frequently co-occurred with the representative word of the respective topic in positive data on the respective topic of the cluster) are presented. The top ranked attribute words for a positive cluster corresponding to a respective topic allow the product researcher to see what other words are most frequently mentioned when the respective topic is raised in the selected product research data.

In some embodiments, as shown in the pain point summary 520 in FIGS. 5E-5F, the method 600 further includes, in response to a user request to analyze data with negative sentiment for the selected product research data, and in accordance with a portion of the selected product research data that corresponds to negative sentiments for a respective topic, presenting a plurality of sub-topics of the respective topic that are present in the portion of the selected product research data that corresponds to negative sentiments for the respective topic; and displaying one or more representative reviews from the portion of the selected product research data for each of the plurality of sub-topics. For example, for the topic “sound”, the sub-topics are ((a) a first sub-topic focused on “noise, loud, annoying, clicking, white” and (b) a second sub-topic focused on “low, high, speed”)). In another example, for the first sub-topic “It makes loud and annoying noise. It also makes clicking noise when oscillating or rotating” and for the second sub-topic “The noise for low speed is like the one for high speed for other fans”. In some embodiments, a plurality of sub-topics of a respective topic that are present in a portion of the selected product research data that corresponds to negative sentiments for the respective topic (e.g., for the topic “sound”, the sub-topics are ((a) a first sub-topic focused on “noise, loud, annoying, clicking, white” and (b) a second sub-topic focused on “low, high, speed”)) are determined through the topic extraction process. In some embodiments, a first total quantity of the portion of the selected product research data that corresponds to negative sentiments for the respective topic (e.g., “bad=3755”), a second total quantity of the portion of the selected product research data corresponds to the plurality of sub-topics of the respective topic (e.g., “count=3559”), and respective shares of the second total quantity corresponding to each of the plurality of sub-topics of the respective topic (e.g., 74% for the first sub-topic, and 26% for the second sub-topic) are also determined and presented with the one or more representative reviews from the selected product research data for each of the plurality of sub-topics. In some embodiments, the above is displayed for each of a plurality of top-ranked topics with negative sentiments (e.g., topics with a large number of negative data).

In some embodiments, as shown in the positioning graph 530 or positioning chart 540 in FIGS. 5G-5H, the method 600 further includes, for a respective topic (e.g., “wash”), identifying a plurality of sub-groups of products (e.g., brand, or model, country of sale, etc.) in a portion of the selected product research data identified using the first filter corresponding to one or more selected collections of products (e.g., a group of related products, a type of product, a brand of products, etc.); and displaying a visual representation (e.g., a bar, a ball, etc., with (X, Y, Φ)) corresponding to a respective sub-group of the plurality of sub-groups of products, wherein the visual representation (e.g., a single object, as opposed to numerical values or separate objects) has a first visual characteristic (e.g., a vertical position on a plane that corresponds to a first value on the vertical axis, a color, etc.) that corresponds to an average sentiment value (e.g., Y) calculated based on the results of the sentiment analysis for a respective portion of the selected product research data that corresponds to the respective topic and the respective sub-group, a second visual characteristic (e.g., a horizontal position on the plane that corresponds to a second value on the horizontal axis) that corresponds to a total quantity of review (e.g., X) in the respective portion of the selected product research data, and a third visual characteristic (e.g., lateral dimension of a bar or a radius of a circle) that corresponds to a total number of topic mentions (e.g., Φ) for the respective sub-group for the respective topic among the total quantity of reviews in the respective portion of the selected product research data that corresponds to the respective topic (e.g., “wash”) and the respective sub-group of the plurality of sub-groups of products.

In some embodiments, for a respective sub-group of the plurality of sub-groups of products, the method 600 includes calculating an average sentiment value based on the results of the sentiment analysis for a respective portion of the selected product research data that corresponds to the respective topic (e.g., “wash”) and the respective sub-group of the plurality of sub-groups of products. In some embodiments, for the respective sub-group of the plurality of sub-groups of products, the method 600 includes calculating a total quantity of reviews (or other types of metrics (e.g., sale volume, customer calls, returns, etc.)) in the respective portion of the selected product research data that corresponds to the respective topic (e.g., “wash”) and the respective sub-group of the plurality of sub-groups of products. In some embodiments, for the respective sub-group of the plurality of sub-groups of products, the method 600 includes calculating a total number of topic mentions for the respective sub-group among the total quantity of reviews.

In some embodiments, as shown in FIG. 5A regarding the topic mode switching button 612, the method 600 further includes, receiving, in a fourth user interface region, a user selection between a first option associated with a topic mode and a second option associated with a keyword mode. In accordance with a determination that the user selection corresponds to the first option, and in response to the request to display the integrated sentiment review, the method 600 includes presenting, in the second user interface region, the integrated sentiment review including the top-ranked topics and respective visual representations of consumer sentiment for each of the top-ranked topics based on the topic extraction from the selected product research data. In accordance with a determination that the user selection corresponds to the second option, and in response to the request to display the integrated sentiment review, the method 600 includes presenting, in the second user interface region, the integrated sentiment review including a plurality of keywords (e.g., words with the highest occurrence rates in the selected product research data) and respective visual representations for of sentiment words associated the plurality of keywords respectively that are extracted from the selected product research data.

In some embodiments, as shown in the comparison user interface 550 in FIG. 51, the method 600 further includes receiving, in a fifth user interface region, a request to present a first comparison summary (e.g., attribute-sentiment graph) of respective quantitative measures of sentiment (e.g., sentiment score, positive, neutral, negative) of a plurality of selected attributes (e.g., topics, attribute words selected by the user) between first and second selected groups of products (e.g., manufacturers, brands, models by the same or different manufacturers of the same product, different website sources). The request further requests to present a second comparison summary (e.g., attribute-popularity graph) of respective quantitative measures of mention frequency (e.g., popularity, times of mentions in the reviews for the corresponding attributes (e.g., within a selected time period)) of the plurality of selected attributes between the first and second selected groups of products. In some embodiments, the device displays a plurality of fields in the fifth user interface region, including a first set of fields each of which includes a drop-down menu listing a plurality of selectable groups, such as brands, manufacturers, models, etc., and a second set of fields each of which includes a drop-down menu listing a plurality of selectable attributes. Upon selection for displaying a total times of mention, a field associated with time frame (e.g., research data within a period of time, or during when the product was reviewed/mentioned, etc.).

In some embodiments as shown in FIG. 5I, in response to receiving the request to present the first comparison summary and the second comparison summary, the method includes (1) displaying the selected attributes at the corners of a respective polygon for each of the first and second selected groups of products; (2) identifying sentiment scores for each attribute, and (3) identifying a total number of reviews that mentioned each attribute word for each of the first and second selected groups of products. In some embodiments, for each selected group of products, the method includes calculating a percentage for each attribute that is associated with a number of reviews for each attribute divided by a total number of reviews of all selected attribute (e.g., attribute popularity). In some embodiments, the method includes determining an average sentiment score for each attribute (e.g., a sentiment score between −1 and +1).

In some embodiments as shown in FIG. 5I, the method includes presenting, in a first view within a sixth user interface region, the first comparison summary of (e.g., the attribute-sentiment that compares) respective sentiment scores of the plurality of selected attributes (e.g., represented by respective attribute words on each corner of the polygon) between the first and second selected groups of products; and presenting, in a second view side-by-side with the first view within the sixth user interface region, the second comparison of (e.g., the attribute-popularity that compares) respective mention frequencies of the plurality of selected attributes between the first and second selected groups of products.

FIG. 7 is a flowchart of a method 700 of facilitating product research and development, in accordance with some embodiments. The method is performed (702) at a computing system (e.g., the server-side functions on the server system 120) having one or more processors and memory. In some embodiments, the method 700 includes obtaining (704) respective product-related data from a plurality of data sources. In some embodiments, the product-related data includes (1) respective product-specific data and (2) non-product-specific data for a plurality of products. In some embodiments, the respective product-specific data includes consumer review data of a category of products (e.g., a category of appliances, cosmetics, electronics, clothing, or furniture, etc.) or one or more related category of products (e.g., categories corresponding to various types of kitchen appliances, various types of home appliances, various types of clothing, or various types of furniture, etc.), such as consumer review data of one or more categories of products (e.g., a particular product with a model and brand) extracted from one or more ecommerce websites. In some embodiments, a category of product corresponds to a specific type of product that is associated with a brand and a model, e.g., a dishwasher of Model #aaa manufactured by AAA company. In some embodiments, the respective product-specific data includes product usage data of a category of products or one or more related categories of products, such as feedback or usage logs transmitted from the appliances, sales reports from sellers and distributors, and sales report transmitted from e-commerce portals. In some embodiments, the consumer review data includes consumer comments provided on online portals, market surveys, pre-sale inquiries, customer support calls, product research results, etc., and the product usage data includes statistics for sales, usage frequencies, customer call frequencies, etc. for each product, category of products, or related categories of products. In some embodiments, the consumer review data takes the form of textual content in natural language, ratings, and the product usage data take the form of statistics, electronic logs, etc. In some embodiments, the non-product-specific data includes at least one of talent profile data of an industry corresponding to the plurality of products (e.g., including job posting data published by one or more industry players (e.g., manufacturers and distributors of the plurality of products) and technology description data for one or more technical areas related to the plurality of products. In some embodiments, the technology description data includes published patents and publications, academic papers, industry conference proceedings, industry white papers, etc.

In some embodiments, the method 700 includes performing (706) topic extraction on the respective product-specific data (e.g., user selected) for a plurality of products (e.g., on the review data of the products from online portals, ecommerce websites, etc.) and the non-product-specific data (e.g., the job posting data, and the patent data for the industry and technical areas related to the plurality of products) to obtain respective topics associated with the plurality of products and corresponding numerical statistics for the respective topics (e.g., frequency count, percentage of occurrences, etc.). For example, the topic extraction uses clustering and topic extraction models and algorithms to process the respective product-related data from a plurality of data sources.

In some embodiments, the method 700 includes performing (708) sentiment analysis on the respective product-specific data (e.g., including the review data of the products from online portals, ecommerce web sites, etc.) for a plurality of products for the respective topics extracted from the respective product-specific data and the non-product-specific data, to obtain respective values of a measure of consumer sentiment (e.g., respective statistics, such as frequency count, percentage of occurrences, etc.) of positive sentiment and negative sentiment) corresponding to the respective topics for a respective product of the plurality of products. In some embodiments, each product may have different sentiment results for each topic.

In some embodiments, the method 700 includes presenting (710) an integrated sentiment review of a selected product based on the respective values of the measure of consumer sentiment corresponding to one or more of the respective topics (e.g., top five most frequently discussed topics) for the selected product. In some embodiments, the integrated sentiment review includes a bar graph contrasting the total number of positive versus negative reviews for a respective topic for the respective product.

In some embodiments, performing sentiment analysis on the respective product-specific data for the plurality of products for the respective topics extracted from the respective product-specific data and the non-product-specific data, to obtain the respective values of the measure of consumer sentiment corresponding to the respective topics for the respective product of the plurality of products includes: for each of the respective topics for the respective product of the plurality of products, obtaining a quantitative measure of positive consumer sentiment and a quantitative measure of negative consumer sentiment from the sentiment analysis on respective product-specific data corresponding to said each of the respective products.

In some embodiments, presenting the integrated sentiment review includes, for each of a plurality of top-ranked topics that are extracted for the selected product, obtaining a quantitative measure of positive consumer sentiment and a quantitative measure of negative consumer sentiment from the sentiment analysis on respective product-specific data corresponding to the selected product. In some embodiments, the top-ranked topics are distinct from the words with the highest occurrence rates in the selected product research data. In some embodiments, the integrated sentiment review of the selected product includes a first visual representation of the quantitative measure of positive consumer sentiment adjacent a second visual representation of the quantitative measure of negative consumer sentiment.

In some embodiments, the method 700 further includes obtaining one or more positive clusters, wherein a respective positive cluster of the one or more positive clusters is associated with a representative word of a respective topic and a plurality of attribute words that occurred in the same context as the representative word of the respective topic.

In some embodiments, in response to a user request to analyze data with negative sentiment for the selected product research data, the method 700 further includes obtaining a plurality of sub-topics of a respective topic from a portion of the selected product research data that corresponds to the negative sentiment.

In some embodiments, for a respective topic, the method 700 further includes identifying a plurality of sub-groups of products in a portion of the selected product research data identified by one or more selected collections of products. In some embodiments, for a respective sub-group of the plurality of sub-groups of products, the method 700 further includes calculating an average sentiment value based on the results of the sentiment analysis for a respective portion of the selected product research data that corresponds to the respective topic and the respective sub-group of the plurality of sub-groups of products; calculating a total quantity of reviews in the respective portion of the selected product research data that corresponds to the respective topic and the respective sub-group of the plurality of sub-groups of products; calculating a total number of topic mentions for the respective sub-group among the total quantity of reviews; and generating a visual representation including visual characteristics corresponding to the average sentiment value, the total quantity of reviews, and the total number of topic mentions respectively.

In some embodiments, in response to a user request to present the integrated sentiment review using a topic mode, the method 700 further includes obtaining a plurality of topics and consumer sentiment data associated with the plurality of topics respectively based on the topic extraction from the selected product research data. In some embodiments, in response to a user request to present the integrated sentiment review using a keyword mode, the method 700 further includes obtaining a plurality of keywords and sentiment words associated the plurality of keywords respectively that are extracted from the selected product research data.

In some embodiments, in response to receiving a user request to present product comparison summaries between first and second selected groups of products, the method 700 further includes obtaining respective quantitative measures of sentiment of a plurality of selected attributes between first and second selected groups of products; obtaining respective quantitative measures of mention frequency of the plurality of selected attributes between the first and second selected groups of products; and generating a first comparison summary of respective sentiment scores of the plurality of selected attributes between the first and second selected groups of products, and a second comparison summary of respective mention frequencies of the plurality of selected attributes between the first and second selected groups of products.

In some embodiments, the method 700 further includes performing sentiment analysis on the technology description data of the non-product-specific data to obtain respective values of a measure of technical development trend (e.g., old/past/outdated technology vs. future/trending technology) corresponding to one or more respective topics for the respective product of the plurality of products (e.g., in a patent, background/problem section vs. detailed description section of the current application). In some embodiments, the integrated sentiment review of the respective product is presented further based on the respective values of the measure of technical development trend corresponding to the one or more respective topics for the respective product.

In some embodiments, prior to performing the topic extraction and sentiment analysis, the method 700 further includes processing the product-specific data and the non-product-specific data using natural language processing (NLP) algorithm.

In some embodiments, the product-specific data for the plurality of products includes product usage data obtained by respective sensors associated with one or more categories of products. In some embodiments, the method 700 further incudes performing feature extraction on the product usage data to obtain respective features associated with the plurality of products and corresponding representations reflecting user preferences associated with the respective features.

In some embodiments, performing the topic extraction further comprises dividing text data of the product-specific data and the non-product-specific data into a plurality of sentences, each sentence including a plurality of words; tagging the plurality of words of a respective sentence of the plurality of sentences with respective word tags (verb, noun, adjective, etc.); analyzing one or more adjacent words of a respective word of the plurality of words in the respective sentence; and extracting one or more topics of the respective sentence according to the word tags and the one or more adjacent words of the respective words in the respective sentence.

The various features described with respect to FIGS. 6 and 7 may be individually implemented, or implemented in combination on the same device or in the same method in accordance with various embodiments.

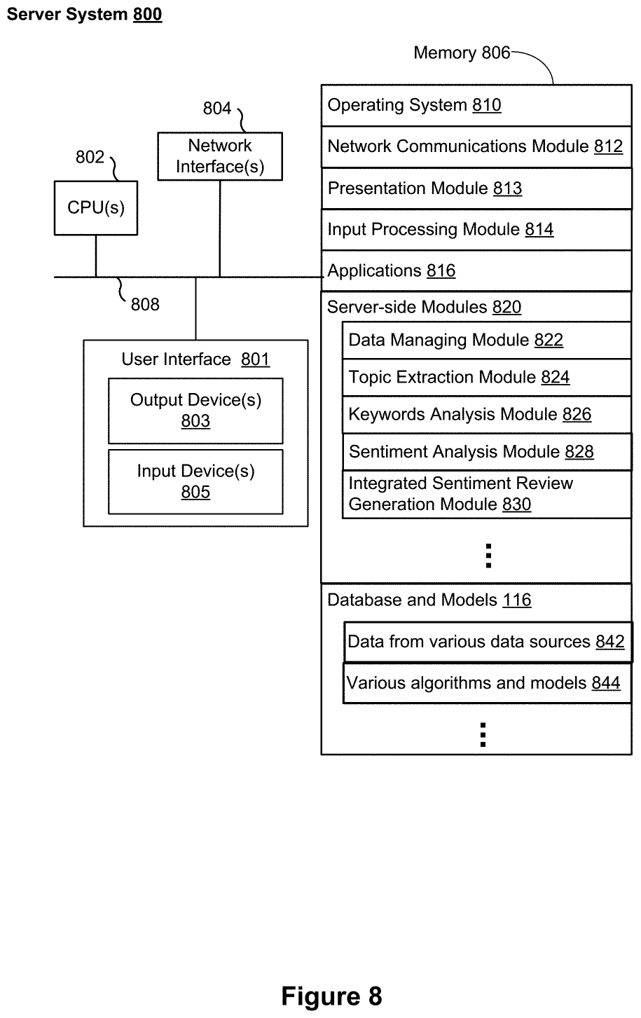

FIG. 8 is a block diagram illustrating a server system (e.g., the server 120) for implementing the method (e.g., the method 700 of FIG. 7) for facilitating product research and development, in accordance with some embodiments. Server 120, typically, includes one or more processing units (CPUs) 802, one or more network interfaces 804, memory 806, and one or more communication buses 808 for interconnecting these components (sometimes called a chipset). Server 120 also optionally includes a user interface 801. User interface 801 includes one or more output devices 803 that enable presentation of media content, including one or more speakers and/or one or more visual displays. User interface 801 also includes one or more input devices 805, including user interface components that facilitate user input such as a keyboard, a mouse, a voice-command input unit or microphone, a touch screen display, a touch-sensitive input pad, a gesture capturing camera, or other input buttons or controls. Memory 806 includes high-speed random access memory, such as DRAM, SRAM, DDR RAM, or other random access solid-state memory devices; and, optionally, includes non-volatile memory, such as one or more magnetic disk storage devices, one or more optical disk storage devices, one or more flash memory devices, or one or more other non-volatile solid-state storage devices. Memory 806, optionally, includes one or more storage devices remotely located from one or more processing units 802. Memory 806, or alternatively the non-volatile memory within memory 806, includes a non-transitory computer readable storage medium. In some implementations, memory 806, or the non-transitory computer readable storage medium of memory 806, stores the following programs, modules, and data structures, or a subset or superset thereof:
operating system 810 including procedures for handling various basic system services and for performing hardware dependent tasks;
network communication module 812 for connecting server 120 to other computing devices (e.g., user devices 102 or third-party services 158) connected to one or more networks 160 via one or more network interfaces 804 (wired or wireless);
presentation module 813 for enabling presentation of information (e.g., a user interface for application(s), widgets, web pages, audio and/or video content, text, etc.) at server 120 via one or more output devices 803 (e.g., displays, speakers, etc.) associated with user interface;
input processing module 814 for detecting one or more user inputs or interactions from one of the one or more input devices 805 and interpreting the detected input or interaction;
one or more applications 816 for execution by server 120;
server-side modules 820, which provides server-side data processing and functionalities for facilitating the product research and development as discussed herein, including but not limited to:
   data managing module 822 for managing data obtained from the external services 158, including but not limited to the product-specific data including appliances sensor data, customer review data, etc. and non-product specific data including talent profile data and technology description data, etc.;
   topic extraction module 822 for performing topic extraction on selected product research data;
   keywords analysis module 824 for analyzing keywords from the selected product research data (e.g., under the non-topic mode);
   sentiment analysis module 828 for identifying sentiment for each extracted topic word from the user review data and performing quantitative evaluation of the corresponding sentiment (e.g., assigning a sentiment score) etc.;
   integrated sentiment review generation module 830 for generating various embodiments of the integrated sentiment review as discussed with reference to FIGS. 5A-5I;
server-side database and models 116, which stores data and related models, including but not limited to:
   data from various data sources 842 as discussed herein, including but not limited to, product-specific data including customer review data, call center complaint data, appliance sensor data, etc. and non-product specific data including talent profile data and technology description data; and
   various algorithms and models 844 as discussed herein, including but not limited to topic extraction algorithm 314, sentiment analysis algorithm 316, feature extraction algorithm 318, and NLP processing algorithm, etc..

Each of the above-identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 806, optionally, stores a subset of the modules and data structures identified above. Furthermore, memory 806, optionally, stores additional modules and data structures not described above.

In some embodiments, at least some of the functions of server system 120 are performed by client device 102, and the corresponding sub-modules of these functions may be located within client device 102 rather than server system 120. In some embodiments, at least some of the functions of client device 102 are performed by server system 120, and the corresponding sub-modules of these functions may be located within server system 120 rather than client device 102. Client device 102 and server system 120 shown in the Figures are merely illustrative, and different configurations of the modules for implementing the functions described herein are possible in various embodiments.

While particular embodiments are described above, it will be understood it is not intended to limit the application to these particular embodiments. On the contrary, the application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

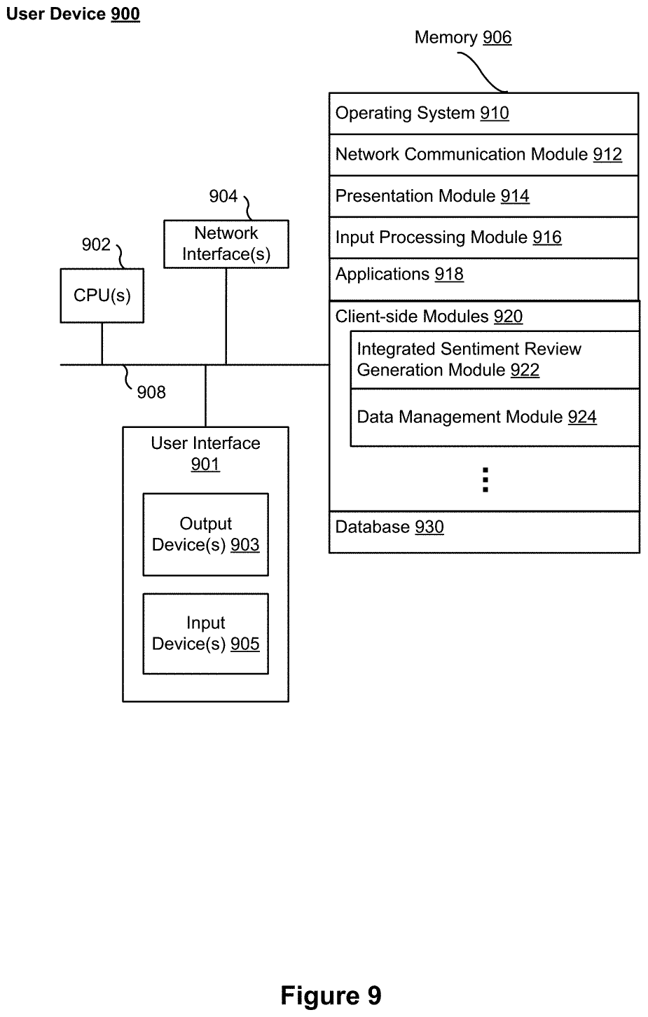

FIG. 9 is a block diagram illustrating a computing device 900 (e.g., user device 102) for performing the method (e.g., the method 600 of FIG. 6) for facilitating product research and development and displaying various embodiments of the integrated sentiment reviews, in accordance with some embodiments. User device 102, typically, includes one or more processing units (CPUs) 902 (e.g., processors), one or more network interfaces 904, memory 906, and one or more communication buses 908 for interconnecting these components (sometimes called a chipset). User device 102 also includes a user interface 901. User interface 901 includes one or more output devices 903 that enable presentation of media content, including one or more speakers and/or one or more visual displays. User interface 901 also includes one or more input devices 905, including user interface components that facilitate user input such as a keyboard, a mouse, a voice-command input unit or microphone, a touch screen display, a touch-sensitive input pad, a gesture capturing camera, one or more cameras, depth camera, or other input buttons or controls. Furthermore, some user devices 102 use a microphone and voice recognition or a camera and gesture recognition to supplement or replace the keyboard. In some embodiments, user device 102 further includes sensors, which provide context information as to the current state of user device 102 or the environmental conditions associated with user device 102. Sensors include but are not limited to one or more microphones, one or more cameras (e.g., used to capture images of the dishwasher chamber in response to receiving user input from the user interface of the application running on the user device 102), an ambient light sensor, one or more accelerometers, one or more gyroscopes, a GPS positioning system, a Bluetooth or BLE system, a temperature sensor, one or more motion sensors, one or more biological sensors (e.g., a galvanic skin resistance sensor, a pulse oximeter, and the like), and other sensors.

Memory 906 includes high-speed random access memory, such as DRAM, SRAM, DDR RAM, or other random access solid-state memory devices; and, optionally, includes non-volatile memory, such as one or more magnetic disk storage devices, one or more optical disk storage devices, one or more flash memory devices, or one or more other non-volatile solid-state storage devices. Memory 906, optionally, includes one or more storage devices remotely located from one or more processing units 902. Memory 906, or alternatively the non-volatile memory within memory 906, includes a non-transitory computer readable storage medium. In some implementations, memory 906, or the non-transitory computer readable storage medium of memory 906, stores the following programs, modules, and data structures, or a subset or superset thereof:
operating system 910 including procedures for handling various basic system services and for performing hardware dependent tasks;
network communication module 912 for connecting user device 102 to other computing devices (e.g., server system 120) connected to one or more networks 160 via one or more network interfaces 904 (wired or wireless);
presentation module 914 for enabling presentation of information (e.g., a user interface for presenting text, images, video, webpages, audio, etc.) at client device 102 via one or more output devices 903 (e.g., displays, speakers, etc.) associated with user interface;
user input processing module 916 for detecting one or more user inputs or interactions from one of the one or more input devices 905 and interpreting the detected input or interaction;
one or more applications 918 for execution by user device 102 (e.g., appliance manufacturer hosted application for managing and controlling the appliance, payment platforms, media player, and/or other web or non-web based applications, etc.);
client-side modules 920, which provides client-side data processing and functionalities, including but not limited to:
   integrated sentiment review generation module 922 (e.g., client-side functionalities) for generating various embodiments of the integrated sentiment review as discussed with reference to FIGS. 5A-5I based on the extracted topics and corresponding sentiment for each topic; and
   data management module 924 (e.g., client-side functionalities) for managing data obtained from the external services 158 and/or the server system 120, including but not limited to the product-specific data and non-product data as discussed herein.
database 930 for storing various data, models, and algorithms as discussed herein.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various implementations. In some implementations, memory 906, optionally, stores a subset of the modules and data structures identified above. Furthermore, memory 906, optionally, stores additional modules and data structures not described above.

The invention can be applied to any applications such as web application, software, or mobile application and can be applied to any type of product planning, evaluation, optimization process within the company or market. No specific industry is restricted.

The foregoing description, for purpose of explanation, has been described with reference to specific embodiments. However, the illustrative discussions above are not intended to be exhaustive or to limit the disclosed embodiments to the precise forms disclosed. Many modifications and variations are possible in view of the above teachings. The embodiments were chosen and described in order to best explain the principles and practical applications of the disclosed ideas, to thereby enable others skilled in the art to best utilize them with various modifications as are suited to the particular use contemplated.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “upon a determination that” or “in response to determining” or “in accordance with a determination” or “upon detecting” or “in response to detecting” that the stated condition precedent is true, depending on the context.

1. A method of facilitating product research and development, comprising:
at a computer system having one or more processors and memory:
obtaining respective product-related data from a plurality of data sources, including (1) respective product-specific data for a plurality of products, and (2) non-product-specific data including talent profile data, including job posting data, of an industry corresponding to the plurality of products and technology description data for one or more technical areas related to the plurality of products;
performing topic extraction on the respective product-specific data for the plurality of products and on the non-product-specific data, including performing topic extraction on the talent profile data, including the job posting data, in conjunction with the respective product-specific data, to obtain respective topics associated with the plurality of products and corresponding numerical statistics for the respective topics;
performing sentiment analysis on the respective product-specific data for the plurality of products for the respective topics that have been extracted from the respective product-specific data and the non-product-specific data, including one or more topics that have been extracted from the talent profile data, including the job posting data, in conjunction with the respective product-specific data, to obtain respective values of a measure of consumer sentiment corresponding to the respective topics for a respective product of the plurality of products; and
presenting an integrated sentiment review of a selected product based on the respective values of the measure of consumer sentiment corresponding to one or more of the respective topics for the selected product.

2. The method of claim 1, wherein performing sentiment analysis on the respective product-specific data for the plurality of products for the respective topics extracted from the respective product-specific data and the non-product-specific data, to obtain the respective values of the measure of consumer sentiment corresponding to the respective topics for the respective product of the plurality of products includes:
for each of the respective topics for the respective product of the plurality of products, obtaining a quantitative measure of positive consumer sentiment and a quantitative measure of negative consumer sentiment from the sentiment analysis on respective product-specific data corresponding to said each of the respective products.

3. The method of claim 1, wherein the product-specific data for the plurality of products includes product usage data obtained by respective sensors associated with one or more categories of products, and wherein the method further comprises:
performing feature extraction on the product usage data to obtain respective features associated with the plurality of products and corresponding representations reflecting user preferences associated with the respective features.

4. The method of claim 1, including:
in response to a user request to analyze data with negative sentiment for first selected product research data, obtaining a plurality of sub-topics of a respective topic from a portion of the first product research data that corresponds to the negative sentiment.

5. The method of claim 1, including:
for a respective topic, identifying a plurality of sub-groups of products in a portion of first product research data identified by one or more selected collections of products; and
for a respective sub-group of the plurality of sub-groups of products:
calculating an average sentiment value based on the results of the sentiment analysis for a respective portion of the first product research data that corresponds to the respective topic and the respective sub-group of the plurality of sub-groups of products;
calculating a total quantity of reviews in the respective portion of the first selected product research data that corresponds to the respective topic and the respective sub-group of the plurality of sub-groups of products; and
calculating a total number of topic mentions for the respective sub-group among the total quantity of reviews; and
generating a visual representation including visual characteristics corresponding to the average sentiment value, the total quantity of reviews, and the total number of topic mentions respectively.

6. The method of claim 1, including:
in response to a user request to present the integrated sentiment review using a topic mode, obtaining a plurality of topics and consumer sentiment data associated with the plurality of topics respectively based on the topic extraction from first product research data; and
in response to a user request to present the integrated sentiment review using a keyword mode, obtaining a plurality of keywords and sentiment words associated the plurality of keywords respectively that are extracted from the first product research data.

7. The method of claim 1, including:
in response to receiving a user request to present product comparison summaries between first and second selected groups of products:
obtaining respective quantitative measures of sentiment of a plurality of selected attributes between first and second selected groups of products;
obtaining respective quantitative measures of mention frequency of the plurality of selected attributes between the first and second selected groups of products; and
generating a first comparison summary of respective sentiment scores of the plurality of selected attributes between the first and second selected groups of products, and a second comparison summary of respective mention frequencies of the plurality of selected attributes between the first and second selected groups of products.

8. A computing system, comprising:
one or more processors; and
memory storing instructions, the instructions, when executed by the one or more processors, cause the processors to perform operations comprising:
obtaining respective product-related data from a plurality of data sources, including (1) respective product-specific data for a plurality of products, and (2) non-product-specific data including talent profile data, including job posting data, of an industry corresponding to the plurality of products and technology description data for one or more technical areas related to the plurality of products;
performing topic extraction on the respective product-specific data for the plurality of products and on the non-product-specific data, including performing topic extraction on the talent profile data, including the job posting data, in conjunction with the respective product-specific data, to obtain respective topics associated with the plurality of products and corresponding numerical statistics for the respective topics;
performing sentiment analysis on the respective product-specific data for the plurality of products for the respective topics that have been extracted from the respective product-specific data and the non-product-specific data, including one or more topics that have been extracted from the talent profile data, including the job posting data, in conjunction with the respective product-specific data, to obtain respective values of a measure of consumer sentiment corresponding to the respective topics for a respective product of the plurality of products; and
presenting an integrated sentiment review of a selected product based on the respective values of the measure of consumer sentiment corresponding to one or more of the respective topics for the selected product.

9. The computing system of claim 8, wherein performing sentiment analysis on the respective product-specific data for the plurality of products for the respective topics extracted from the respective product-specific data and the non-product-specific data, to obtain the respective values of the measure of consumer sentiment corresponding to the respective topics for the respective product of the plurality of products includes:
for each of the respective topics for the respective product of the plurality of products, obtaining a quantitative measure of positive consumer sentiment and a quantitative measure of negative consumer sentiment from the sentiment analysis on respective product-specific data corresponding to said each of the respective products.

10. The computing system of claim 8, wherein the product-specific data for the plurality of products includes product usage data obtained by respective sensors associated with one or more categories of products, and wherein the operations further include:
performing feature extraction on the product usage data to obtain respective features associated with the plurality of products and corresponding representations reflecting user preferences associated with the respective features.

11. The computing system of claim 8, wherein the operations further include:
in response to a user request to analyze data with negative sentiment for first product research data, obtaining a plurality of sub-topics of a respective topic from a portion of the first product research data that corresponds to the negative sentiment

12. The computing system of claim 8, wherein the operations further include:
for a respective topic, identifying a plurality of sub-groups of products in a portion of first product research data identified by one or more selected collections of products; and
for a respective sub-group of the plurality of sub-groups of products:
calculating an average sentiment value based on the results of the sentiment analysis for a respective portion of the first product research data that corresponds to the respective topic and the respective sub-group of the plurality of sub-groups of products;
calculating a total quantity of reviews in the respective portion of the first selected product research data that corresponds to the respective topic and the respective sub-group of the plurality of sub-groups of products;
calculating a total number of topic mentions for the respective sub-group among the total quantity of reviews; and
generating a visual representation including visual characteristics corresponding to the average sentiment value, the total quantity of reviews, and the total number of topic mentions respectively.

13. The computing system of claim 8, wherein the operations further include:
in response to a user request to present the integrated sentiment review using a topic mode, obtaining a plurality of topics and consumer sentiment data associated with the plurality of topics respectively based on the topic extraction from first product research data; and
in response to a user request to present the integrated sentiment review using a keyword mode, obtaining a plurality of keywords and sentiment words associated the plurality of keywords respectively that are extracted from the first product research data.

14. The computing system of claim 8, wherein the operations further include:
in response to receiving a user request to present product comparison summaries between first and second selected groups of products:
obtaining respective quantitative measures of sentiment of a plurality of selected attributes between first and second selected groups of products;
obtaining respective quantitative measures of mention frequency of the plurality of selected attributes between the first and second selected groups of products; and
generating a first comparison summary of respective sentiment scores of the plurality of selected attributes between the first and second selected groups of products, and a second comparison summary of respective mention frequencies of the plurality of selected attributes between the first and second selected groups of products.

15. A non-transitory computer-readable storage medium storing instructions, the instructions, when executed by one or more processors, cause the processors to perform operations comprising:
obtaining respective product-related data from a plurality of data sources, including (1) respective product-specific data for a plurality of products, and (2) non-product-specific data including talent profile data, including job posting data, of an industry corresponding to the plurality of products and technology description data for one or more technical areas related to the plurality of products;
performing topic extraction on the respective product-specific data for the plurality of products and on the non-product-specific data, including performing topic extraction on the talent profile data, including the job posting data, in conjunction with the respective product-specific data, to obtain respective topics associated with the plurality of products and corresponding numerical statistics for the respective topics;
performing sentiment analysis on the respective product-specific data for the plurality of products for the respective topics that have been extracted from the respective product-specific data and the non-product-specific data, including one or more topics that have been extracted from the talent profile data, including the job posting data, in conjunction with the respective product-specific data, to obtain respective values of a measure of consumer sentiment corresponding to the respective topics for a respective product of the plurality of products; and
presenting an integrated sentiment review of a selected product based on the respective values of the measure of consumer sentiment corresponding to one or more of the respective topics for the selected product.

16. The computer-readable storage medium of claim 15, wherein performing sentiment analysis on the respective product-specific data for the plurality of products for the respective topics extracted from the respective product-specific data and the non-product-specific data, to obtain the respective values of the measure of consumer sentiment corresponding to the respective topics for the respective product of the plurality of products includes:
for each of the respective topics for the respective product of the plurality of products, obtaining a quantitative measure of positive consumer sentiment and a quantitative measure of negative consumer sentiment from the sentiment analysis on respective product-specific data corresponding to said each of the respective products.

17. The computer-readable storage medium of claim 15, wherein the product-specific data for the plurality of products includes product usage data obtained by respective sensors associated with one or more categories of products, and wherein the operations further include:
performing feature extraction on the product usage data to obtain respective features associated with the plurality of products and corresponding representations reflecting user preferences associated with the respective features.

18. The computer-readable storage medium of claim 15, wherein the operations further include:
in response to a user request to analyze data with negative sentiment for first product research data, obtaining a plurality of sub-topics of a respective topic from a portion of the first product research data that corresponds to the negative sentiment.

19. The computer-readable storage medium of claim 15, wherein the operations further include:
for a respective topic, identifying a plurality of sub-groups of products in a portion of first product research data identified by one or more selected collections of products; and
for a respective sub-group of the plurality of sub-groups of products:
calculating an average sentiment value based on the results of the sentiment analysis for a respective portion of the first selected product research data that corresponds to the respective topic and the respective sub-group of the plurality of sub-groups of products;
calculating a total quantity of reviews in the respective portion of the first product research data that corresponds to the respective topic and the respective sub-group of the plurality of sub-groups of products;
calculating a total number of topic mentions for the respective sub-group among the total quantity of reviews; and
generating a visual representation including visual characteristics corresponding to the average sentiment value, the total quantity of reviews, and the total number of topic mentions respectively.

20. The computer-readable storage medium of claim 15, wherein the operations further include:
in response to a user request to present the integrated sentiment review using a topic mode, obtaining a plurality of topics and consumer sentiment data associated with the plurality of topics respectively based on the topic extraction from first product research data; and
in response to a user request to present the integrated sentiment review using a keyword mode, obtaining a plurality of keywords and sentiment words associated the plurality of keywords respectively that are extracted from the first product research data.
